(19) United States
(12) Patent Application Publication
(10) Pub. No.: US 2026/0252197 A1
(43) Pub. Date: Aug. 27, 2026

(54) METHODS AND SYSTEMS FOR SMART ACOUSTIC MULTIMODAL INTERFACES

(71) Applicant: UNIVERSITY OF ROCHESTER, Rochester, NY (US)

(72) Inventors: Michael Charles HEILEMANN, Henrietta,, NY (US); Mark Frederick BOCKO, Caledonia,, NY (US); Joseph James DIPASSIO, III, Rochester,, NY (US)

(21) Appl. No.: 18/877,305

(22) PCT Filed: Jun. 27, 2023
(86) PCT No.: PCT/US2023/069140

§ 371 Date: Dec. 20, 2024

Related U.S. Application Data
(60) Provisional application No. 63/367,341, filed on Jun. 30, 2022.

(51) Int. Cl. G06F 3/043

(52) U.S. Cl. CPC G06F 3/043

(57) ABSTRACT

The present application discloses systems and methods for developing acoustic and touch interfaces using one or more structural vibration sensors affixed to a surface. The method utilizes the resonant properties of the structure and machine learning to infer information about the source such as the position of a sound source in a room or the location the structure was touched. The application further discloses systems utilizing methods may reduce the number of sensors needed for applications such as sound-source localization, acoustic beamforming and touch interfacing, reduce the manufacturing cost of implementing the systems, and improve device durability when compared with systems currently used for the aforementioned applications.

This application claims priority from U.S. Provisional Application No. 63/367,341, filed Jun. 30, 2022, which is incorporated herein by reference.

### FIELD

The application relates to the field of vibrational acoustics and specifically to the design of base surfaces as multimodal acoustic interfaces.

### BACKGROUND

Many devices such as smart phones, speakers, and personal assistants capture audio using MEMS microphones. These microphones have similar functional capabilities as conventional condenser microphones used in audio recording, with dimensions scaled down to only a few millimeters, allowing them to be easily integrated into compact electronic devices. MEMS microphones sample changes in acoustic pressure at a single point in space (the location of the microphone) and have a generally flat frequency response within the bandwidth of 100 Hz-10 kHz.

Additionally, a lot of devices use microphone arrays for acoustic source localization. In a smart-speaker for example, the device listens for the keyword (Ex. “Alexa”), determines the direction-of-arrival of the sound source that produced the keyword, and then uses acoustic beamforming in the direction of the source to reduce signal corruption by other noise sources in the environment. In the simplest case, one could estimate the direction of an incoming audio source by setting up three microphones, and measuring the time difference between the signals arriving at each microphone as shown in FIG. 1A. Each set of time differences corresponds to a specific direction of arrival.

MEMS microphones require case penetrations for the microphone to detect acoustic pressure waves in the air. These case penetrations make the device susceptible to damage from water and dust. There is a need for a device that will perform the same functions as MEMS microphones, but without the drawbacks attendant to case penetrations, and with fewer sensing elements in the array.

### SUMMARY

An aspect of the present application is a method for capturing directional sound using structural vibration sensing elements, the method comprising the steps of: affixing one or more structural vibration sensing elements to an elastic base surface; detecting vibrations in the elastic base surface that are sensed by the structural vibration sensing element, wherein said vibrations are caused by acoustic pressure waves impacting upon said elastic base surface; measuring a vibration signal from the vibrations in said base surface in response to the acoustic pressure waves that are impacting upon said elastic base surface; inferring from the vibration signal in said elastic base surface the incident angle of the acoustic pressure waves at the point of impact on said elastic base surface, wherein inferences of the incident angle of the acoustic pressure waves are drawn based on vibration features extracted from the vibration signal that provide information on the relative modal excitations of the elastic base surface by the vibrations.

Another aspect of the present application is a system for capturing directional sound using structural vibration sensing elements, the system comprising: one or more structural vibration sensing elements, wherein a structural vibration sensing element is affixed to an elastic base surface; a network connected to the structural vibration sensing element for capturing directional sound by: detecting vibrations in the elastic base surface that are sensed by the structural vibration sensing element, wherein said vibrations are caused by acoustic pressure waves impacting upon said elastic base surface; measuring a vibration signal from the vibrations in said base surface in response to the acoustic pressure waves that are impacting upon said elastic base surface; inferring from the vibration signal in said elastic base surface the incident angle of the acoustic pressure waves at the point of impact on said elastic base surface, wherein inferences of the incident angle of the acoustic pressure waves are drawn based on vibration features extracted from the vibration signal that provide information on the relative modal excitations of the elastic base surface by the vibrations.

Another aspect of the present application is a method for capturing touch location on the surface of an elastic object using structural vibration sensing elements, the method comprising the steps of: affixing one or more structural vibration sensing elements to an elastic base surface; detecting vibrations in the base surface that are sensed by the structural vibration sensing element, wherein said vibrations are caused by a touch impacting upon said base surface; measuring a vibration signal caused by said touch impacting upon said base surface; inferring from the vibration signal the position of the touch at the point of impact on the base surface, wherein inferences of the position of the touch are drawn based on vibration measurements extracted from the vibration signal that provide information on the relative modal excitations of the base surface by the vibrations.

Another aspect of the present application is a system for capturing touch location using structural vibration sensing elements, the system comprising: one or more structural vibration sensing elements, wherein a structural vibration sensing element is affixed to an elastic base surface; a network connected to the structural vibration sensing element for capturing touch location by: detecting vibrations in the base surface that are sensed by the structural vibration sensing element, wherein said vibrations are caused by a touch impacting upon said base surface; measuring a vibration signal caused by said touch impacting upon said base surface; inferring from the vibration signal the position of the touch at the point of impact on the base surface, wherein inferences of the position of the touch are drawn based on vibration measurements extracted from the vibration signal that provide information on the relative modal excitations of the base surface by the vibrations.

Another aspect of the present application is a method for crosstalk cancellation on a flat panel speaker, the method comprising the steps of: affixing a structural vibration sensing element to a base surface; detecting a first set of vibrations in the base surface that are sensed by the structural vibration sensing element, wherein said first set of vibrations are caused by touch inputs or acoustic pressure waves impacting upon said base surface; detecting a second set of vibrations in the base surface that are sensed by the structural vibration sensing element, wherein said second set of vibrations are caused by one or more dynamic force actuators impacting upon said base surface, wherein said one or more dynamic force actuators have a transfer function to the structural vibration sensing element that remains constant; subtracting the signal from the actuators filtered by the transfer function from the signal detected by the structural vibration sensing element from both sets of vibrations, so as to obtain the signal received by the structural vibration sensing element from the first set of vibrations.

Another aspect of the present application is a system for crosstalk cancellation on a flat panel speaker, the system comprising: a structural vibration sensing element, wherein the structural vibration sensing element is affixed to a base surface; a computer processor, wherein the computer processor is networked to the structural vibration sensing element; a non-transitory computer-readable medium having computer-executable instructions stored thereon, said computer-readable instructions for crosstalk cancellation on a flat panel speaker by: detecting a first set of vibrations in the base surface that are sensed by the structural vibration sensing element, wherein said first set of vibrations are caused by touch inputs or acoustic pressure waves impacting upon said base surface; detecting a second set of vibrations in the base surface that are sensed by the structural vibration sensing element, wherein said second set of vibrations are caused by one or more dynamic force actuators impacting upon said base surface, wherein said one or more dynamic force actuators have a transfer function to the structural vibration sensing element that remains constant; subtracting the signal from the actuators filtered by the transfer function from the signal detected by the structural vibration sensing element from both sets of vibrations, so as to obtain the signal received by the structural vibration sensing element from the first set of vibrations.

There are a variety of embodiments which may be embodied separately or together in combination in the aspects of the application; an independent listing of an embodiment herein below does not negate the combination of any particular embodiment with the other embodiments listed herein.

### BRIEF DESCRIPTION OF THE DRAWINGS

FIG. 1A shows conventional method for measuring direction-of-arrival, noting that for an excitation signal s (t), the signals recorded at each microphone are s (t-t1), s (t-t2) and s (t-t3) respectively. The time differences between the three signals can be calibrated to a particular incident angle of the acoustic source relative to the microphone array;

FIG. 1B shows a pressure wave pᵢ(x, y, t) incident to a baffled panel surface at angles φi and θi.

FIG. 2A shows a panel loudspeaker with four force actuators and one piezoelectric vibration sensor (a structural vibration sensing element);

FIG. 2B shows an acrylic panel with a 26 cm by 36 cm active surface area was mounted to a rotational device in a semi-anechoic setting. Five sensors were affixed to the panel, four at the midpoints of the sides of a rectangle that is concentric with the panel's frame with a length of 21.6 cm and width of 15.6 cm, and one in the center.

FIG. 3A shows the impulse responses for each panel used in this experiment are fitted with decay curves and plotted. Because of the exponential nature of the decay, t_{1/2} can be extracted from the curves and used to calculate Rₘ as shown in equation (5);

FIG. 3B shows the magnitude of the frequency responses of each panel which are then plotted. In general, increasing panel damping yields a flatter magnitude response, while reducing panel damping introduces reverberant high-Q modes into the response;

FIG. 3C shows selected MFCC Coefficients extracted from a recording made of a panel's response to the speech sound “eh” ([ε] in the International Phonetic Alphabet) incident at −30°, 0°, and 45°.

FIG. 4A shows a deep neural network (DNN) is employed to determine the direction of arrival from the distinct speech sounds contained in the excitation signal “excite”. In this algorithm, the stop “k” isn't utilized as it contains much less energy than the other sounds. The estimations can be used individually or in aggregate.

FIG. 4B shows a model trained with data from one sensor affixed to an aluminum based panel is used to estimate DOA from the test set. The estimates from each ground truth angle in the test set are plotted in 5° bins.

FIG. 4C shows a model trained with data from one sensor affixed to an acrylic panel is used to estimate DOA from the test set. The estimates from each ground truth angle in the test set are plotted in 5° bins.

FIG. 5 shows spectrogram of dialog snippet in isolation recorded by a panel, which is the target for the resulting post-cancellation spectrograms from cancelling the different types of actuator signal. Cancellation results for the panel are shown in FIGS. 6-8.

FIG. 6 shows spectrogram of recorded dialog while white noise was played by actuators before and after cancellation.

FIG. 7 shows spectrogram of recorded dialog while classical music was played by actuators before and after cancellation.

FIG. 8 shows spectrogram of recorded dialog while a synthesized speech passage was played by actuators before and after cancellation.

FIG. 9 shows a simulation of the response of a panel to touch inputs in the middle and upper left corners. The response is shown at the location of the touch points.

FIG. 10 shows vision of surfaces as multimodal interfaces that combine audio capture, touch input, audio reproduction, image reproduction, and haptic feedback. Potential applications are shown in the color box corresponding to each capability or are blended between colors that require more than one feature of the interface.

FIG. 11 shows velocity response of the panel showing the isolated modal regions that would be excited by incident acoustic waves.

FIG. 12 shows a panel's isolated resonances cuts off at a significantly lower frequency (~2 kHz) than the human auditory system (~20 kHz).

FIG. 13 shows examples of MFCC, Magnitude spectrogram, and Mel spectrogram feature vectors extracted from recordings of the trigger phrase “Hey Alexa” made by a single vibration sensor affixed to an acrylic panel

FIG. 14 shows confusion matrix showing the average distribution of the DOA estimates returned by a model trained with the female voice. The bin size is chosen to visualize an angular tolerance of ±5°.

While the present disclosure will now be described in detail, and it is done so in connection with the illustrative embodiments, it is not limited by the particular embodiments illustrated in the figures and the appended claims.

### DETAILED DESCRIPTION OF THE INVENTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended claims, the singular forms “a,” “an” and “the” include plural referents unless the content clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself.

Herein, the term “structural vibration sensor” or “structural vibration sensing element” refers to vibration sensors or strain sensors collectively or individually.

The average velocity response of an elastic panel can be measured with a scanning laser vibrometer. Such an elastic panel vibrates with many resonances that are isolated in the frequency domain based on their resonant frequencies and bandwidths. The work herein demonstrates that the amplitude to which each of these resonances is excited is a function of the angle of incidence of the excitation. Therefore, given enough information and experimental data, a measurement of the panel's vibration in response to an acoustic stimulus can be used to estimate direction of arrival by associating the spectral content of the vibration with the incident angle of the excitation. This application uses frequency-domain (spectral) representations of the panel's vibrations that are captured by vibration sensors to derive feature sets that enable models to estimate acoustic direction of arrival (DOA).

One aspect of the present application described herein involves the use of a structural sensor to infer directional information about a sound source. The structural sensor measures the acoustic signal coupled via the induced vibrations in the structure. Since different incident angles give different relative structural excitations, features can be extracted from the recorded signal, and used to infer the incident angle based on the relative modal excitations of the structure. In certain embodiments, mel-frequency cepstral coefficients (MFCCs) measure the energy in particular frequency bands. In preferred embodiments, the optimal filter bands are designed based on the specific resonant frequencies of the structure, obtained via a model or direct measurement. In certain embodiments, the methods and systems herein are applied in acoustic beamforming, where the microphone listens in a specific direction (blocking out noise coming in from other directions).

Another aspect of the present application described herein involves the use of a structural sensor to infer the location of a touch input. The system may be “passive”—where the structural sensor records the vibrations induced by the touch input directly, “active”—where an external actuator induces vibrations in the structure and the structural sensor records changes in the recorded signal when touched, or a combination of the two (passive until initial touch is detected, then active response). In a particular embodiment, in an active system, the source signal is synthesized to optimally excite the modes of the system that give the most spatial information. In certain embodiments, the methods and systems herein are applied in large signage/displays where capacitive touch interfaces would be cost-prohibitive.

Another aspect of the present application is the system to remove the loudspeaker signal from the audio signal recorded by a vibration sensor as described herein. In particular, the audio signal corrupting the recording (music, speech, etc.) is known, and the transfer function between the loudspeaker actuators and the vibration sensor remains constant. As long as the transfer function remains known, it may be applied to the known signal and subtracted from the sensor recording. In specific embodiments, the methods and systems herein are applied to duplex devices like smart speakers, where the device needs to listen for new commands while playing audio. In certain embodiments, the system and methods described herein may also be used to remove the loudspeaker signal from the recorded signal if the source signal is instead generated by a touch input.

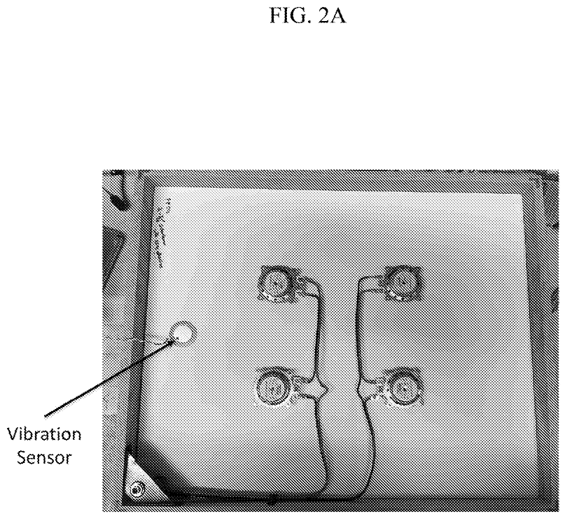

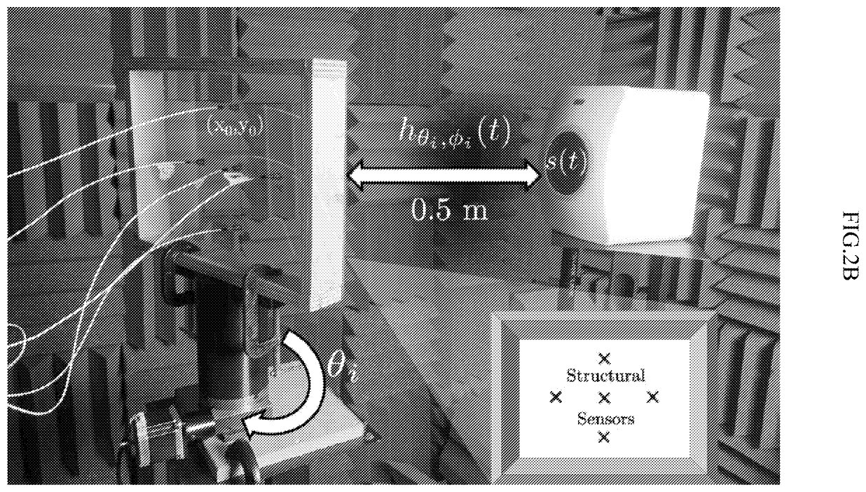

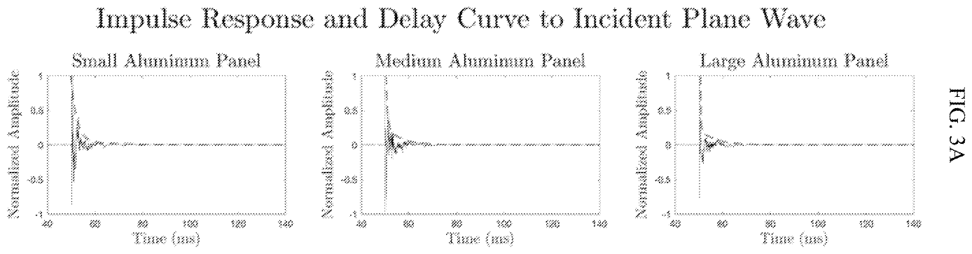

Panels, and other thin, solid structures are sensitive to changes in air pressure. Acoustic pressure waves generated by the human voice are strong enough to induce vibrations in the structure that can be detected by sensors such as accelerometers or piezoelectric transducers affixed to the surface as shown in FIG. 2A.

For recordings made with vibration sensors, the resonances of the structure introduce reverberation into the audio signal, which degrades the quality of the recorded audio compared to traditional microphones. Structures with more damping introduce less reverberation into the recorded signal and produce higher quality recordings. Though panel microphones would never be considered for high-end studio recordings, the studies described herein show that speech transmission index scores are only slightly lower than those produced by conventional studio microphones. In other words, the quality is not degraded enough to be unintelligible. Speech recordings made by structural vibration sensors and transcribed by automatic speech recognition systems produce similar word-error-rates when compared with conventional studio microphones. The speech transmission index scores and the word-error-rates (percentage of incorrect transcriptions) are shown in Table 1 for three panels made of different materials. To summarize, though the quality of the audio is objectively degraded when using a structural vibration sensor to record the audio, the recording is still sufficient for automatic speech recognition software to function effectively and for humans to understand what is being said.

TABLE 1
Speech transmission index and word-error-rates for panel microphones
of different materials compared to an F130F20 Free-Field microphone
made by PCB Piezotronics microphone. Average STI and WER scores
for the each of the panel materials, and the standard deviations
among small, medium, and large panel sizes. Higher damping is
shown to improve both STI and WER score.

| | Average | σ | Average | σ WER |
|---|---|---|---|---|
| Material | STI Score | STI | WER (%) | (%) |
| Aluminum | .983 | .007 | 10.1 | 0.47 |
| Acrylic | .922 | 0.01 | 11.5 | 0.42 |
| Gatorboard | .908 | 0.03 | 13.6 | 0.44 |
| Reference Microphone | .980 | | 9.33 | |

The structural vibration sensors described herein offer distinct advantages over MEMS microphones. The structural vibration sensors described herein are affixed directly to, or embedded within the surface itself, meaning that the device can be fully sealed, as no case penetrations are required for operation.

Different excitation signals, such as touching the surface in different locations, or speaking at varying angles of incidence, excite the resonant modes of a structure in distinct ways. A neural network is trained to identify the differences between the responses due to different source excitation signals, and extract information about the source (such as the touch location or incident angle) by measuring the vibration response in one or more locations on the structural surface.

The best directional sensors (sound or touch) will have many high-Q modes resonating in the operating frequency bandwidth. For a microphone, this would be the bandwidth of human speech. For an active touch sensor, the active signal may be designed so that its bandwidth encapsulates the resonant frequencies of the vibration modes of the structure that give the most spatial information. Each mode has a particular spatial response, so the combination of many modes implies a specific initial excitation.

High-Q resonant modes do reduce the quality and intelligibility of the recorded audio signal, but not enough to significantly affect the ability of speech recognition systems or human listeners to accurately interpret the recorded speech data.

MFCCs essentially divide the spectrum of a signal into logarithmically-spaced frequency bands and report the energy in each band. The vibration modes of the structure each have a different resonant frequency, so the MFCCs approximate the relative excitations of different modes. Each combination of relative modal excitations (or MFCCs) provides specific spatial information about the excitation source.

MFCCs are only one embodiment. They work well in general because the resonant modes that convey a lot of spatial information typically lie in different bands on the mel scale (known as mel-frequency cepstral coefficients or MFCC's).

However, for example, a very small, thick panel could have no modes resonating in the first 2-3 mel bands, or a very large, thin panel could have 20 or more modes in the first 2-3 mel bands. A preferred embodiment selects filter bands whose frequencies are informed by the resonances of the structure. That way, each band essentially represents one mode. These frequencies can be determined by modeling the structure, or taking empirical measurements.

In a similar manner, the source signal used for an active touch sensor can also be tailored to match the resonant frequencies of panel modes that contain the most spatial information. Current methods use either a broadband noise signal, or a harmonically rich waveform. In a certain embodiment, the source signal may be synthesized to contain only the spatially important resonant frequencies of the structure for maximum efficiency. This would not require the use of a filter bank since the signal would be separated into bands directly.

### Design of Flat Panel Acoustic Surfaces

The out-of-plane displacement \tilde{φ} at time t and point (x,y) on a damped, isotropic panel's of bending stiffness D and density r subject to external load p(x, y,t) is shown [Cremer, M. Heckl, and B. Petersson, Structure-Borne Sound: Structural Vibrations and Sound Radiation at Audio Frequencies (Springer Berlin Heidelberg, 2005)]:

$$D {∇}^{4} \tilde{φ} ( x , y , t ) + ρ h \ddot{\tilde{φ}} ( x , y , t ) + {R}_{m} \dot{\tilde{φ}} ( x , y , t ) = p ( x , y , t ) , \qquad ( 1 )$$

where h is the thickness of the panel, and Rₘ is the panel's mechanical resistance. The bending stiffness D is determined by the Young's Modulus E, and Poisson's ratio v,

$$D = \frac{{Eh}^{3}}{12 ( 1 - {v}^{2} )} . \qquad ( 2 )$$

In addition to the panel's physical properties, the response of a vibrating panel is also determined by its shape and boundary conditions. In this work, it is assumed the panel is rectangular, with dimensions (Lₓ, L_{y}), and that the edges are fully clamped. Under these boundary conditions, an approximation for the resonant frequency of each bending mode ω, is given by Mitchell and Hazel [A. Mitchell and C. Hazell, “A simple frequency formula for clamped rectangular plates,” Journal of Sound and Vibration, vol. 118, no. 2, pp. 271-281 (1987].

Following Fuller [E. C. Fuller and P. Nelson, Active Control of Vibration (Academic Press, 1996).], the out-of-plane displacement of a panel can be expressed as a superposition of the panel's modes,

$$\tilde{φ} ( x , y , ω ) = {\sum }_{r = 1}^{∞} \frac{{P}_{r} {Φ}_{r} ( x , y )}{ρ h ( {ω}_{r}^{2} - {ω}^{2} + j {ω}_{r} ω / {Q}_{r} ) ,} \qquad ( 3 )$$

where, Φᵣ(x,y) is the shape of each resonant mode's shape, Pris the pressure on each resonant mode due to the input disturbance, ωᵣ is the resonant frequency of each mode, and Qᵣ is the quality factor of each mode given by,

$${Q}_{r} = \frac{{ω}_{r} ρ h}{{R}_{m}} . \qquad ( 4 )$$

The frequency response at a particular sensor location may be derived by evaluating (3) at location (xᵢ, yᵢ) on the surface of the panel. The quality factor for isotropic plates is shown by Fahy and Gardonio to be inversely proportional to the material's damping coefficient [Fahy and P. Gardonio, Sound and Structural Vibration: Radiation, Transmission and Response 2nd Edition. Elsevier Science, 2007].

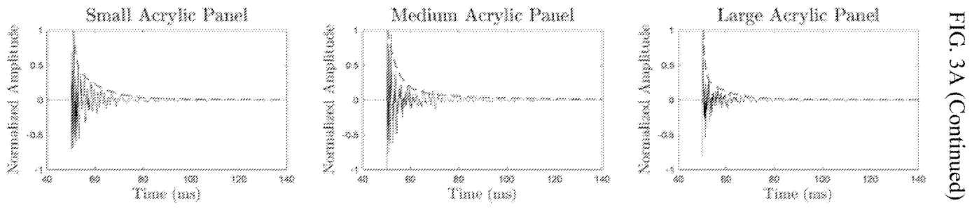

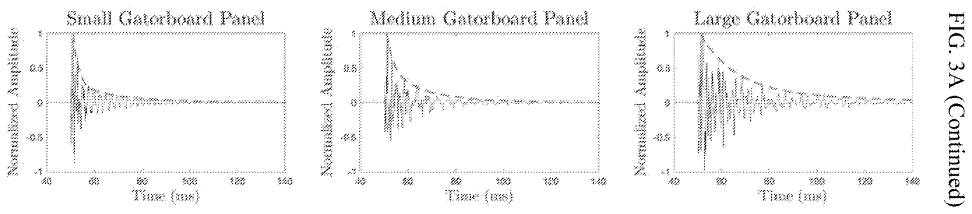

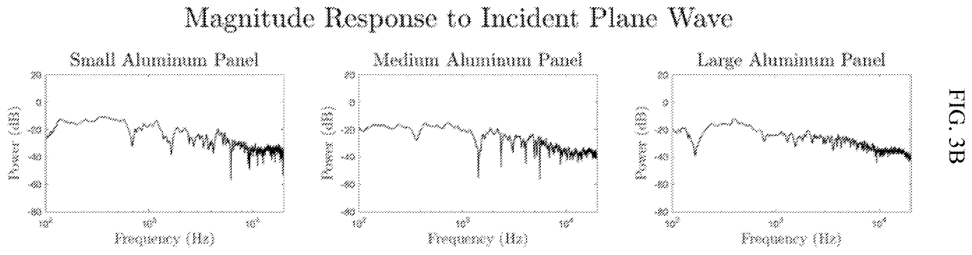

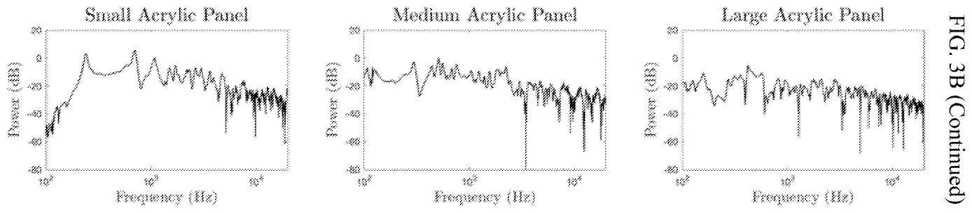

The effective damping varies for each of the panel's bending modes, however an average value for the damping of the panel can be expressed as

$${R}_{m} = \frac{2 ρ h ln ( 2 )}{{t}_{1 / 2}} , \qquad ( 5 )$$

where t_{1/2} is the decay time for the impulse response of the panel to reach one-half amplitude. Impulse responses fit with exponential decay envelopes are shown in FIG. 3A. t_{1/2} can be extracted for each response where the decay envelope reaches its half-amplitude and used in (5) to calculate average Rₘ.

### Using Resonant Modes to Determine Direction of Arrival (DOA)

Consider a panel of thickness h and surface area S placed in an infinite baffle and excited by the incident plane wave

$${p}_{i} ( x , y , t ) = {P}_{i} {e}^{jwt + jk sin {ϕ}_{i} cos {θ}_{i} - jk sin {ϕ}_{i} sin {θ}_{i}} , \qquad ( 6 )$$

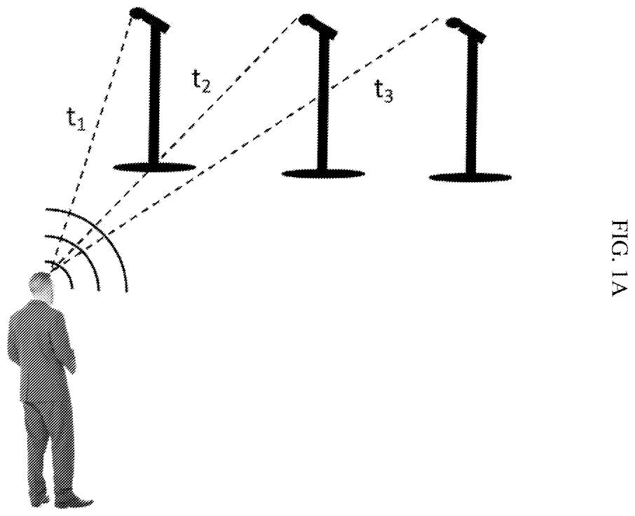

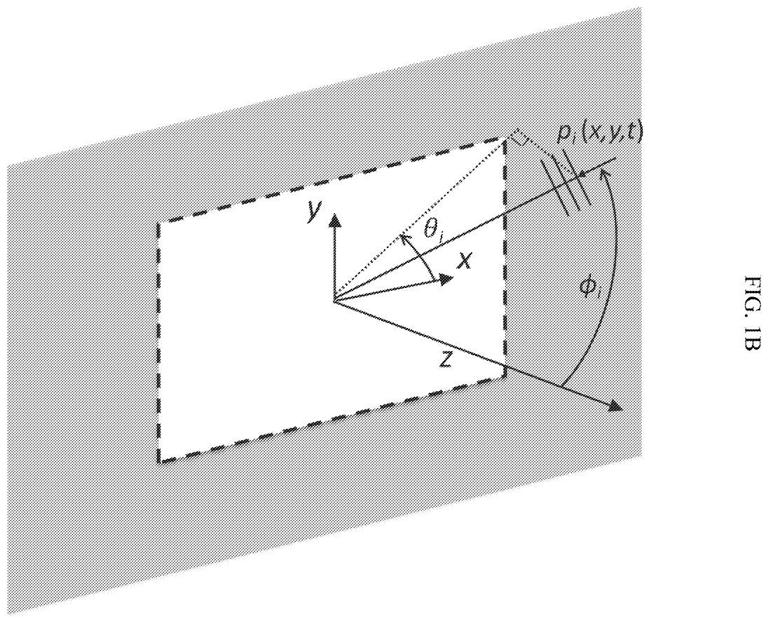

as shown in FIG. 1B, where Pᵢ is the amplitude of the incident wave at frequency ω, k is the wave number, φᵢ is the angle between the incident wave's propagation vector and the axis normal to the panel, and θᵢ is the angle between the in-plane projection of the propagation vector and the horizontal axis.

Following [Fahy and P. Gardonio, Sound and Structural Vibration: Radiation, Transmission and Response 2nd Edition. Elsevier Science, 2007], the out of plane-displacement of the panel z (x, y, t) due to an external disturbance can be expressed as a superposition of panel resonant modes given by,

$$z ( x , y , t ) = {\sum }_{r = 1}^{∞} {A}_{r} {Φ}_{r} ( x , y ) {e}^{j ω t} , \qquad ( 7 )$$

where Aᵣ and Φᵣ are, respectively, the amplitude and spatial response of the r^{th} mode.

From [C. Fuller, S. Elliott, and P. Nelson, Active Control of Vibration. Associated Press, 1996; B. Wang, C. R. Fuller, and E. K. Dimitriadis, “Active control of noise transmission through rectangular plates using multiple piezoelectric or point force actuators,” J. Acoust. Soc. Am., vol. 90, no. 5, pp. 2820-2830, 1991; L. A. Roussos, “Noise transmission loss of a rectangular plate in an infinite baffle,” NASA Technical Paper, no. 2398, 1985], when the external disturbance is a plane wave, Aᵣ is given as a function of the incident angles of the plane wave,

$${A}_{r} ( {θ}_{i} , {ϕ}_{i} ) = \frac{8 {P}_{i} {\overline{I}}_{r} ( {θ}_{i} , {ϕ}_{i} , ω )}{ρ h ( {ω}_{r}^{2} - {ω}^{2} + j {ω}_{r} ω / {Q}_{r} )} , \qquad ( 8 )$$

where ρ is the density of the panel, and ωᵣ and Qᵣ are, respectively, the resonant frequency and quality factor of the r^{th} mode. Īᵣ(θᵢ, φᵢ, ω) is the coupling factor between the pressure distribution on the panel due to the incident wave, and the spatial response of each mode.

From (6) and (7), the response of the panel at a given sensor location (xᵢ, yᵢ) will be dependent upon the incident angles θᵢ and φᵢ of the incoming plane wave for a given frequency. The sensor inputs z (xᵢ, yᵢ, t) are used to train a recurrent neural network to estimate the DOA of the incoming wave.

### Linearity of Panel Vibrations

For flat plates, transverse deflection can produce non-linear vibrational behavior only if the deflection is significant [F. J. Fahy and P. Gardonio, Sound and structural vibration: radiation, transmission and response (Elsevier, 2007).]. In this work, vibrations on the panel's surface will be induced by incident plane waves and by actuators on the panel's surface, which cause displacements on the order of tens of microns. This curvature is a fraction of the panel's minimum material thickness and dimensions, and is well within linear vibrational limits.

Therefore, this work can model the displacement response of the panel at sensor location (xᵢ, yᵢ) to induced vibrations from incident plane waves and actuators as,

$${z}_{( {x}_{i} , {y}_{i} )} [ n ] = s [ n ] \text{?} {h}_{1} [ n ] + x [ n ] \text{?} {h}_{2} [ n ] , \qquad ( 9 )$$

where z_{(xi,yi)}[n] is the panel's displacement at position (xᵢ, yᵢ) at sample n, s[n] is a signal being played by a source in the acoustic half-space in front of the panel, h₁ is the transfer function from the source's location to the panel's sensor, x[n] is the signal being played by the affixed actuators, and h₂ is the transfer function from the actuator's location to the panel's sensor.

One of ordinary skill would understand that the system and methods described herein may be used for detection of a mechanical force acting on a panel, where the force could be from an acoustic wave impinging on the panel or the tactile force from a user touching the panel at one or more locations. In certain embodiments, the system and methods described herein may be used to remove the loudspeaker signal from the recorded signal if the source signal is instead generated by a touch input. In particular, s[n] herein may represent a touch input, instead of an acoustic signal.

### Duplex Mode Cancellation

Because x[n] is directly coupled to the panel's surface and s[n] is inefficiently coupled to the panel's surface, it may be necessary to remove non-zero x[n]. However, since x[n] is directly known by the audio system, and h₂[n] can be determined for drivers at fixed panel locations, approaches such as spectral or time-domain subtraction, source separation, and artificial neural networks may be used to obtain an estimate of s[n] [symbol] h₁[n] from the structural sensor's audio stream.

Herein, the recorded speech signal is given as the convolution s[n] [symbol] h₁[n]. It is show that the audio-degrading effect of h₁[n] creates only negligible effects on the ability of the recorded speech to be used with modern ASR systems.

### Subtraction Method

Because the panel is operating in a linear deflection region, subtraction approaches can theoretically be used to directly cancel the audio from actuators provided the transfer function from the actuator to the sensor, h₂ in (9), is known. In general, this transfer function can be obtained at the time of device assembly as the actuator will never move once it is affixed to the panel's surface. The signal being played by the actuators, x[n] in Equation 9, is known as it is determined by device's the audio reproduction system.

Therefore, (9) may be rewritten to isolate the unknown signal contribution from incident acoustic waves as

$${z}_{( {x}_{i} , {y}_{i} )} [ n ] = x [ n ] \text{?} {h}_{2} [ n ] + x [ n ] \text{?} {h}_{1} [ n ] . \qquad ( 10 )$$

Transfer function h₂ in (10) may be understood as a delay in sequence with a finite impulse response (FIR) filter such that

$${z}_{( {x}_{i} , {y}_{i} )} [ n ] = x [ n ] \text{?} {h}_{2}^{′} [ n - {p}_{d} ] = s [ n ] \text{?} {h}_{1} [ n ] . \qquad ( 11 )$$

where

$${h}_{2}^{′} [ n ]$$

contains the harmonic information from h₂ as an FIR filter with non-zero first tap and p_{d} represents the total delay from the time a sample is played via the actuator to when its response is recorded including propagation delay on the panel's surface and any hardware delays. A precise value for p_{d} is important if subtraction is to be done in discrete time, though spectral subtraction on a frame level may reduce sensitivity to slight drifting of the true value of p_{d}. In this experiment, cross correlation was used to determine a value for p_{d} for each panel. The audio stream recorded by the structural sensor on each panel was then stored in a buffer, while the expected contribution from the actuator signal was calculated and ultimately subtracted in either the sample or frequency domains using (11).

### Neural Network Architecture

In certain embodiments, the neural network used in this application resembles the architecture of classification networks that have demonstrated success in distinguishing noise bursts of different colors [“Classify sound using deep learning.” [Online]. Available: mathworks.com/help/audio/gs/classify-sound-using-deep-learning.html]. Common mel-spectrum features, such as mel-frequency cepstral coefficients (MFCCs) and their delta features, were used to train the model. Of these features tested, MFCCs in isolation gave the best training performance and were thus used as the feature set to train the proposed model, though other features, or combinations of features, may yield better results.

The data set of noise bursts was divided into training, validation, and testing sets, with roughly 150,000 bursts used for network training (30,000 bursts per structural sensor). When training a network, each sensor was in either an ‘on’ or ‘off’ state, whereby the network utilized the data from that sensor or ignored it entirely. It is defined N as the number of sensors that were ‘on’ while training a particular model. With five structural sensors affixed to the panel, there are 31 unique sensor configurations ranging from models trained with a single sensor (N=1) to a model that utilizes data from all sensors (N=5).

Models were trained with the loss function L_{RMSE} which minimizes the root-mean-square error (RMSE) between the ground truth DOA φᵢ and the model's estimated DOA

$${ϕ}_{i}^{p}$$

while learning:

$${L}_{RMSE} = \sqrt{\frac{{\sum }_{i = 1}^{n} {ϕ}_{i} - {ϕ}_{i}^{p}}{n}} . \qquad ( 12 )$$

The validation accuracies while training models across all unique sensor configurations are shown in Table 2. The mean and standard deviation of the RMSE is reported for the total number of configurations of each N. Even with just one sensor, the DOA of bursts from the validation set were consistently predicted to within roughly 3°.

TABLE 2
Statistics regarding RMSE observed when training models
using data from N sensors. Each statistic is computed
using all of the sensor configurations that satisfy N.

| | # of Sensor | Mean | Std. Dev. of |
|---|---|---|---|
| N | Configurations | RMSE | RMSE |
| 1 | 5 | 2.81 | 0.967 |
| 2 | 10 | 0.764 | 0.311 |
| 3 | 10 | 0.610 | 0.069 |
| 4 | 5 | 0.573 | 0.078 |
| 5 | 1 | 0.520 | N/A |

In certain embodiments, the models trained in this work employs two architectures that are compatible with TinyML, and are compact enough to be embedded on commercially available edge devices. The first of two architectures, is a two-dimensional convolution neural network (CNN) with a regression output layer. The second model, a recurrent neural network (RNN) was chosen because it is built into the hardware on the Syntiant NDP. One of ordinary skill will understand that the choice of neural network architecture can be based on the intended use or related design choices.

### Methods of Use

In certain embodiments the methods, systems and devices described herein may be used in connection to sound transmission/reception from systems and devices including, but not limited to, the following: mobile phones, electronic notepads, electronic tablets, electronic automobile dashboards (e.g., in ambulances or cars used for medical-related purposes), electronic motorcycle dashboards, electronic wristbands, electronic neckwear, wall-mounted screens, portable monitors (e.g. wheeled monitors in medical facilities), electronic headbands, electronic helmets, electronic eyewear (e.g. glasses with lens that can display information in real time to the wearer), electronic rings, networked computers (e.g. personal computers), remote viewing technology (e.g. rural doctor client-patient communication devices) and portable electronic devices in general. In certain embodiments, the device may be used in connection with a vibrational sensor, such as a piezoelectric or PVDF sensor, or accelerometer. In certain embodiments, the devices and systems may be used in connection with smart-speakers, surveillance systems, computer monitors, displays, signage, televisions, OLED displays, acoustic beam forming, or any vibrating surface employed as a loudspeaker.

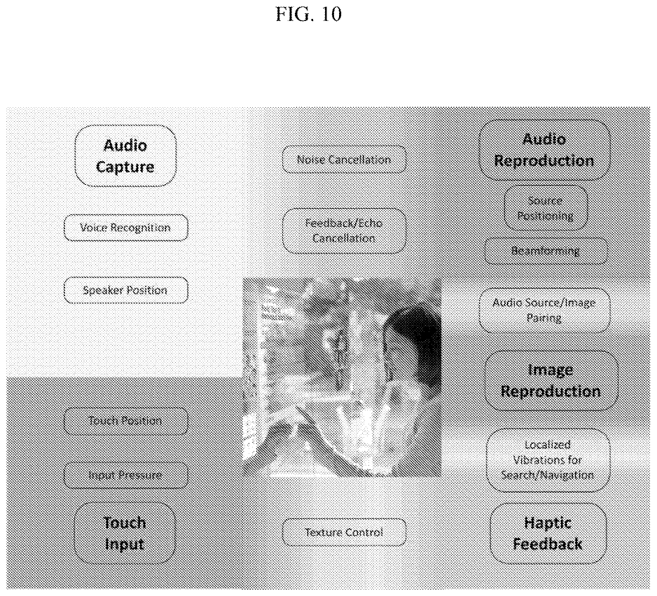

Multimodal interfaces can provide visual, haptic and auditory stimuli to improve a user's ability to navigate complex data sets. The methods and systems herein can support smart acoustic surfaces with the capabilities outlined in FIG. 10, where the areas of audio capture, audio reproduction, touch input and haptic feedback are realized by actuating or sensing vibrations on the display screen itself. The various capabilities may be combined to create features such as noise cancellation, texture control, audio source/image pairing, and the generation of localized panel vibrations to guide touch for search and navigation.

Using the vibrations of the extended surface itself to capture and reproduce spatial audio gives a number of advantages over current systems that employ conventional loudspeakers and microphones. The extended surface can measure the sound-field at multiple locations similar to a conventional microphone array when equipped with an array of vibration sensors. In handheld and personal computing devices, employing the display as the audio interface eliminates the need for case penetrations required by conventional microphones and loudspeakers, which can extend the life of the device by reducing damages caused by water and dust. Using the extended surface to radiate sound allows spatial audio to be integrated into devices and environments such as thin display panels and home-office settings that otherwise would be limited by the form-factor of conventional loudspeaker arrays. The application of this technology is very broad and can range from safety equipment such as surveillance systems and helmets for first responders, to entertainment systems such as televisions that can enhance the user's sense of media immersion by controlling the radiated sound field and reducing background noise. The latter application is especially relevant given the rise of remote interactions in the wake of the current pandemic.

In certain embodiments, the methods and systems herein may be used while immersed in fluid, such as underwater. In particular embodiments, the methods and systems herein may be used for directional sensors underwater. In certain embodiments, the inference of the direction of arrival according to the methods and systems herein is performed specifically using embedded hardware and edge devices.

In one embodiment, the methods and systems herein can fundamentally change the remote education experience. One difficulty with online education is the challenge of finding appropriate remote substitutes for hands-on activities such as labs assignments and field work. Generally, the hands-on activities are replaced by instructor-centered remote activities or simulations, with the instructors perceiving this as having a negative impact on student learning outcomes. While it is obvious that developing interfaces with multimodal capabilities could enhance student learning by providing a more immersive remote experience, it is unrealistic to expect students to have the resources or available space in their homes to put conventional loudspeaker and microphone array systems into practice. The same is true for nearly everyone working remotely. The ability to integrate these large installations into existing home-office environments is an important step toward the widespread use of multimodal interfaces. The methods and systems described herein provide a framework that will allow walls, display screens, picture frames and other extended surfaces already present in homes and offices to be adapted as multimodal interfaces that fit within the form-factor of remote learning and work environments.

### Computer Systems

In certain embodiments the device herein may be used in connection with systems or devices controlled and networked via a computer system, the computer system includes a memory, a processor, and, optionally, a secondary storage device. In some embodiments, the computer system includes a plurality of processors and is configured as a plurality of, e.g., bladed servers, or other known server configurations. In particular embodiments, the computer system also includes an input device, a display device, and an output device.

In some embodiments, the memory includes RAM or similar types of memory. In particular embodiments, the memory stores one or more applications for execution by the processor. In some embodiments, the secondary storage device includes a hard disk drive, floppy disk drive, CD-ROM or DVD drive, or other types of non-volatile data storage.

In particular embodiments, the processor executes the application(s) that are stored in the memory or the secondary storage, or received from the internet or other network. In some embodiments, processing by the processor may be implemented in software, such as software modules, for execution by computers or other machines. These applications preferably include instructions executable to perform the functions and methods described herein. The applications preferably provide GUIs through which users may view and interact with the application(s). In other embodiments, the system comprises remote access to control and/or view the system.

The present application is further illustrated by the following examples that should not be construed as limiting.

### EXAMPLES

### Example 1: Audio Capture Using Structural Sensors in Vibrating Panel Surfaces

Three sizes of panels are tested: small panels with Lₓ=0.18 meters and L_{y}=0.23 meters, medium panels with Lₓ=0.26 meters and L_{y}=0.36 meters, and large panels with Lₓ=0.41 meters and L_{y}=0.51 meters. Three different panel materials are also tested: a 1 millimeter thick aluminum material with an inner layer of viscoelastic adhesive to increase its damping, a 2 millimeter thick acrylic material, and a 3 millimeter polystyrene based foam board material called Gatorboard. Properties of the materials used in this study are summarized in Table 3.

TABLE 3
Properties of the materials used to construct the panels
used in this experiment. Average Rₘ is calculated from (5)
with t_{1/2} extracted from the decay curves in FIG. 3A.
Panel Material Properties

| | Al. Sandwich Panel | Acrylic Panel | Gatorboard Panel |
|---|---|---|---|
| E (GPa) | 68.9 | 3.2 | 1.5 |
| v | 0.334 | 0.35 | 0.35 |
| ρ (kg m⁻³) | 2700 | 1180 | 222 |
| b_{avg} (kg s⁻¹) | 10270 | 2172 | 241.5 |
| h (mm) | 1.0 | 2.0 | 3.0 |

The responses shown in FIG. 3B demonstrate that reducing material damping results in high-Q modes, which are detrimental to speech intelligibility as they can cause ringing, reverberation, and smearing of the audio signal.

The first experiment determined the accuracy with which an ASR system can transcribe audio from humans speaking near a panel when recorded by the structural sensors affixed to the panel. From equation (3), audio recorded using structural sensors on a panel will be subject to reverberation from high-Q modes, a challenge that traditional microphones or arrays do not face. A corpus of 500 sentences of speech recorded by structural sensors on the experiment panels were transcribed to compare the accuracy with those made with a reference microphone.

Each of the nine panels were placed in a semi-anechoic environment and equipped in their center with a PCB Piezotronics U352C66 accelerometer. A KEF LS50 loudspeaker was placed on-axis and half a meter away from the panel's surface, simulating a human speaking at this distance. The impulse response from the KEF to the panel was recorded to obtain an effective transfer function for this use case. Because the deflection of the panel from induced vibrations from the incident waves is well within the linear region of the panel, convolution with the panel's impulse response can be used to simulate how the panel's sensor records the panel's vibration induced under these conditions. This allows efficient testing with a large data set of speech samples. A similar measurement was taken for the Shure SM7b microphone used as a reference.

Recordings of Harvard sentences were used to test how accurately an ASR system can transcribe audio recorded on a panel equipped with a structural sensor, in accordance with the IEEE Recommended Practice for Speech Quality Measurements [“IEEE Recommended Practice for Speech Quality Measurements,” IEEE Transactions on Audio and Electroacoustics, vol. 17, no. 3, pp. 225-246 (1969)]. It is possible that the harmonics of certain speech sounds optimally excite a set of the panel's resonant modes and negatively impact the intelligibility of words containing those sounds. The use of phonetically balanced Harvard sentences ensures that the potential issues caused by these sounds are encapsulated in the experimental results. A male subject with diction training recorded 500 Harvard sentences listed in [“IEEE Recommended Practice for Speech Quality Measurements,” IEEE Transactions on Audio and Electroacoustics, vol. 17, no. 3, pp. 225-246 (1969)]. These recordings could then be recorded by the panel using either the KEF loudspeaker or simulated as such using convolution.

The speech transmission index (STI) was used as a perceptual metric. The STI evaluates the intelligibility of speech through transmission channels using the system's modulation transfer function (MTF) [T. Houtgast and H. J. Steeneken, “The modulation transfer function in room acoustics as a predictor of speech intelligibility,” Acta Acustica United with Acustica, vol. 28, no. 1, pp. 66-73 (1973),]. In this experiment, playing audio through a reference monitor into a semi-anechoic room and inducing vibrations on the surface of the panel serves as a channel, whereby the only reverberation or degradation of the audio signal should occur via the panel's resonances.

Schroeder proposed a method for calculating a MTF from the system's impulse response, enabling indirect calculation of the STI [M. R. Schroeder, “Modulation transfer functions: Definition and measurement,” Acta Acustica united with Acustica, vol. 49, no. 3, pp. 179-182 (1981).]. STI values greater than 0.75 are generally regarded as excellent in quality.

Word error rate (WER) was used to directly compute the accuracy of the transcriptions returned by the ASR system. WER is a measure of Levenshtein distance, describing the rate at which errors occur when comparing a transcription to the known text. Errors include the erroneous insertion of words, the deletion of words, or the substitution of a correct word with an incorrect word. WER is given as a percentage by

$$WER = \frac{Insertions + Deletions + Substitutions}{Number of Words in Reference} * 100 \% . \qquad ( 14 )$$

The impulse responses obtained as described herein were used to obtain STI scores for each of the panels in the semi-anechoic environment. The Harvard sentence recordings described herein were convolved with these impulse responses to simulate a large data set of audio recorded from the structural sensors affixed to the experiment panels. These recordings were transcribed to text via IBM Watson's speech-to-text ASR service, and assigned a WER score when compared to true Harvard Sentence transcripts. Results are discussed herein.

The average STI and WER scores and their standard deviations s for each panel material are tabulated in Table 1 above. For both metrics, the standard deviation is a small fraction of the overall scores, implying that panel size caused only a small effect on the results for the sizes tested. However, the panel's material did appear to cause a noticeable impact on the results. STI increases and WER decreases as the panel's damping increases.

This result follows from the flattening of the frequency response and the reduction of reverberant high-Q modes as damping increases, shown in FIGS. 3A and 3B. In general, every material's STI average is above 0.9, meaning that any material used in this study captured excellent quality recordings according to the standard.

For the WER metric, no panel exceeded the WER reported when using the reference microphone by more than 3.5% even withstanding added reverberation in the lesser-damped panel materials. This experiment shows that the audio recorded through structural sensors affixed to panels is able to be transcribed with modern ASR systems without significant reduction of accuracy.

When an acoustically active surface is used to simultaneously record and reproduce audio, the signal recorded by the affixed structural sensors will contain a mixture of vibration induced by both the affixed actuators and the user's speech. The second experiment explores the use of signal processing to digitally remove the signal played by actuators from the audio stream. In many smart devices, interrupting a song that is playing or stopping an answer that a smart assistant provides is vital to the device's audio-based human-computer interaction (HCI). Vibrations from affixed actuators more efficiently drive the panel's surface than induced vibration from incident plane waves. Therefore, the sensor will observe a larger contribution from the actuators than from the incident sound waves even if both signals contain the same power. This problem of simultaneous playback and recording also affects existing smart audio devices, though on these devices, microphones record both signals as acoustic pressure variations in air, therefore neither has a coupling advantage to the microphone. A subtraction approach was used to show the feasibility of cancelling the vibrations due to the panel's audio stream.

In this experiment, simulation using impulse responses is not possible as cancelling a simulated vibrational contribution would be trivial or require assumptions about environmental and system noise. Instead, a KEF LS50 loudspeaker was placed in the far-field of a panel that is equipped with a structural sensor and an actuator. Harvard Sentence recordings were played via the KEF loudspeaker while audio is simultaneously being played through the actuators. The actuators played three different types of audio: white noise, classical music, and synthesized speech (such as from Amazon's Alexa assistant). This tested the effectiveness of the proposed method on wide-band signals, music, and speech.

In addition to recordings containing a mixture of vibration induced by both actuators and incident acoustic waves, recordings were made of the vibration induced by both sources in isolation. Provided operation in the linear deflection region of the panel, we can obtain the signal-to-noise (SNR) before cancellation as

$$SNR ( dB ) \vert = 10 {log}_{10} ( \frac{{P}_{s}}{{P}_{x}} ) ,$$

where Ps and Px are the power of the signals in the recording from the incident acoustic waves and the induced vibrations from the actuators respectively. SNR is used to evaluate the cancellation algorithm, and is reported herein.

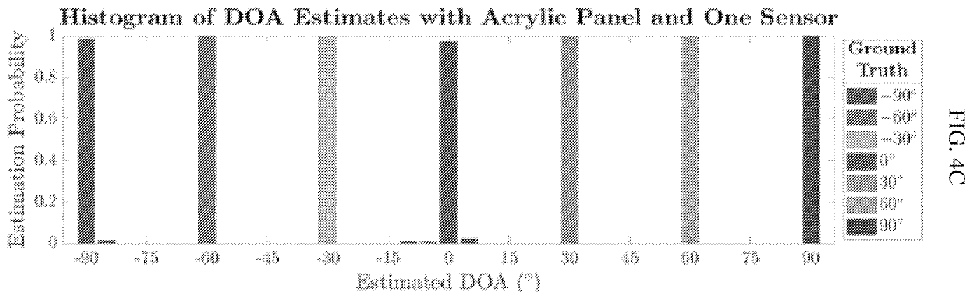

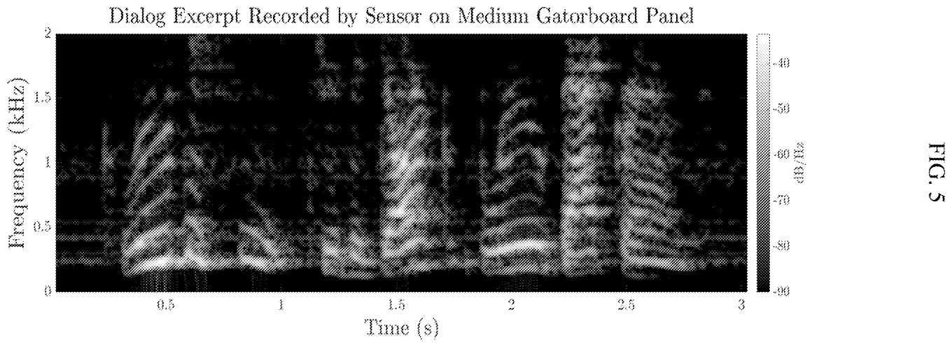

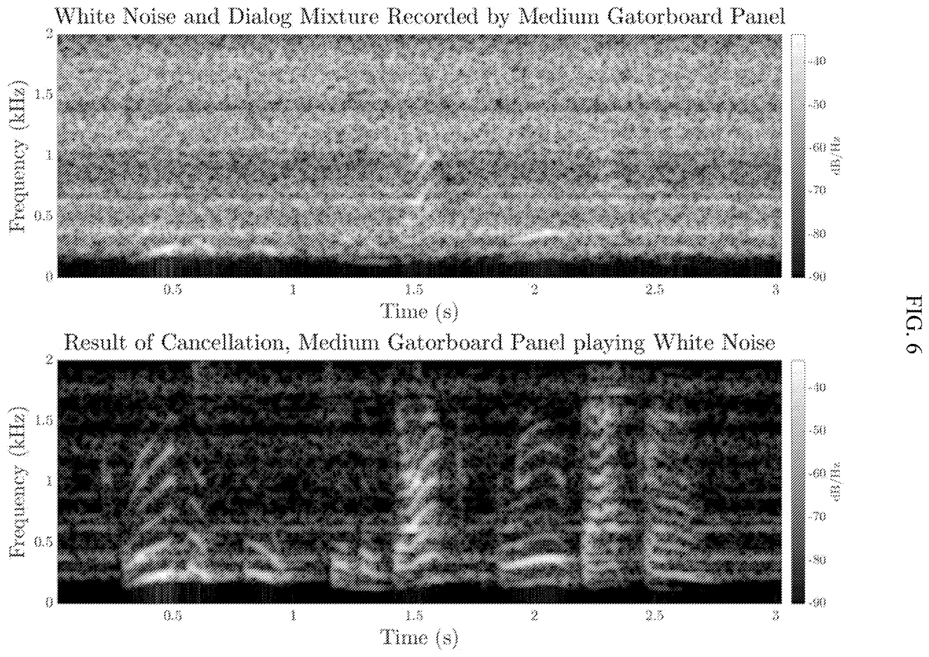

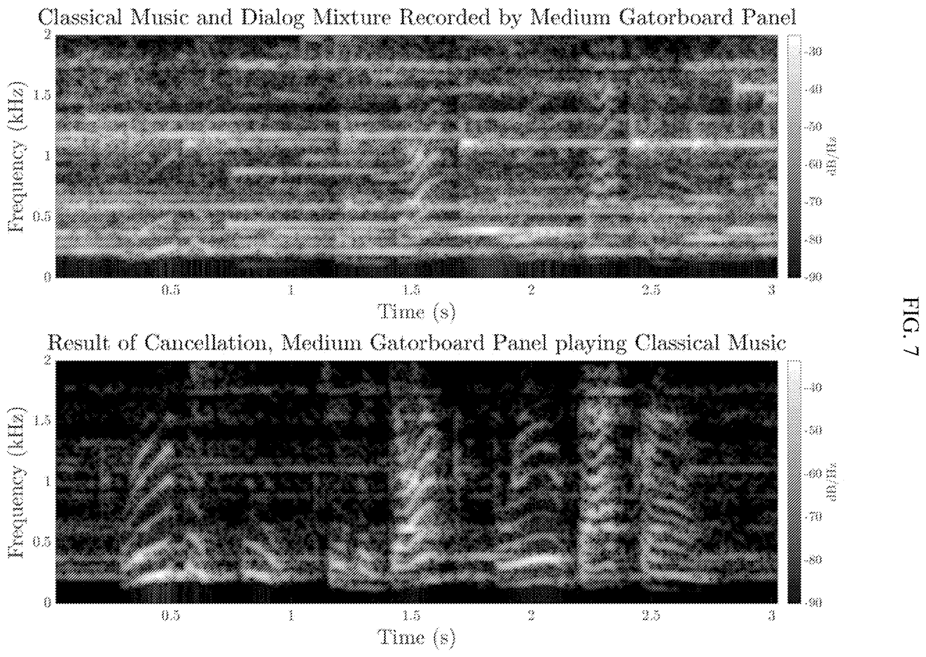

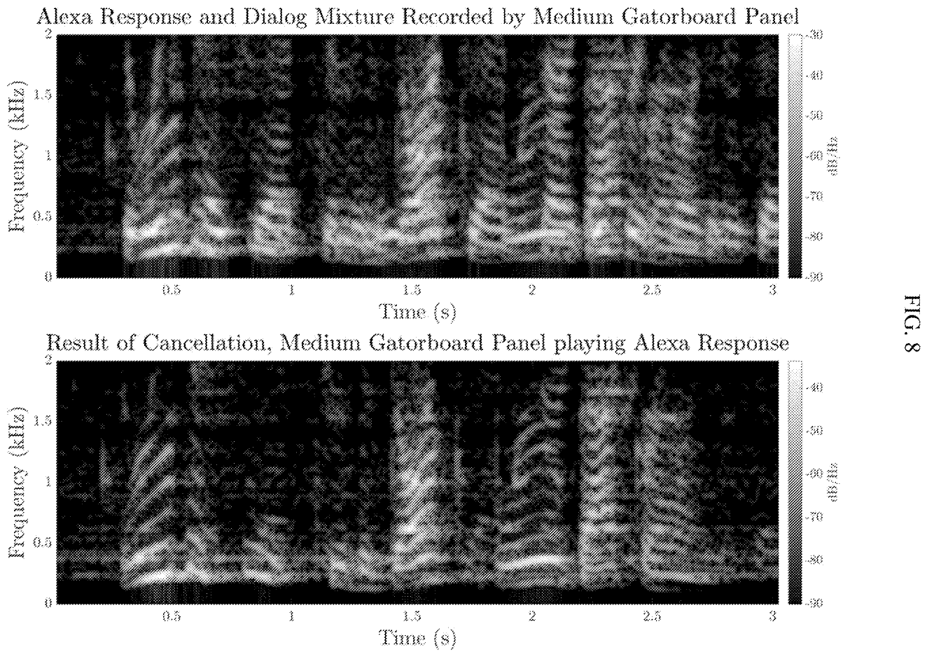

The spectrogram of acoustic waves containing a passage of speech recorded by the medium Gatorboard panel with no contribution from the affixed actuator is shown in FIG. 2A. When the panel records signals that contain contributions from both incident waves and the affixed actuator, the spectrogram shown in FIG. 5 becomes the target spectrogram when applying the cancellation algorithm. Spectrograms showing this dialog snippet in a mixture with the white noise, classical music, and synthesized speech being played by the actuators are shown in FIGS. 6-8. Quantitative results regarding post-cancellation SNR improvement among all panels are tabulated in Table 4.

In general, the subtraction has a large impact on the SNR of the audio stream. SNR increased an average of 51.1 dB among aluminum panels, 40.1 dB among acrylic panels, and 39.3 dB among gatorboard panels. This shows a similar trend to the WER metric results from Table 2, in that more highly damped panels show better reliably in cancelling the actuator's contribution to the audio stream. All SNR improvements reported in Table 4 show the feasibility of removing the highly-coupled actuator contribution to the audio stream.

TABLE 4
SNR improvement in the sensor's audio stream after cancelling
the contribution from the actuators for each panel. Significant
SNR improvements are seen for all three material types.

| | SNR | SNR | SNR | SNR |
|---|---|---|---|---|
| | Increase | Increase | Increase | Increase |
| | (dB) | (dB) | (dB) | (dB) |
| | White | Classical | Alexa | Material |
| Panel Type | Noise | Music | Speech | Average |
| Large Aluminum | 55.3 | 64.1 | 55.5 | 51.1 |
| Medium Aluminum | 53.4 | 53.0 | 44.1 | |
| Small Aluminum | 39.4 | 48.9 | 46.3 | |
| Large Acrylic | 67.6 | 57.2 | 66.6 | 40.1 |
| Medium Acrylic | 33.2 | 28.0 | 23.2 | |
| Small Acrylic | 29.3 | 30.6 | 25.2 | |
| Large Gatorboard | 53.8 | 43.2 | 40.9 | 39.3 |
| Medium Gatorboard | 29.9 | 31.4 | 25.0 | |
| Small Gatorboard | 42.3 | 41.7 | 45.3 | |

### Example 2: Structural Sensors for Predicting Direction of Arrival from Sound Sources

Five PCB Piezotronics U352C66 accelerometers are attached to a panel mounted to a rotary table such that the panel's surface could be rotated between φi=−90° and 90° in 5° increments relative to a KEF LS50 loudspeaker placed on-axis half a meter away (implying θi=0° for all measurements since all incident waves lie in the azimuthal plane) (FIG. 2B). In this way, white noise bursts with a duration of 100 milliseconds were reproduced through the loudspeaker at each rotation angle to excite a vibrational response on the panel's surface which was recorded by the accelerometers. The result of this data acquisition was roughly 400,000 recorded noise bursts split between the five sensors at 37 unique angles of incidence.

The models were evaluated by their ability to correctly estimate DOA within a defined angular tolerance. Following [N. Liu, H. Chen, K. Songgong, and Y. Li, “Deep learning assisted sound source localization using two orthogonal first order differential microphone arrays,” J. Acoust. Soc. Am., vol. 149, no. 2, pp. 1069-1084, 2021; Q. Li, X. Zhang, and H. Li, “Online direction of arrival estimation based on deep learning,” in 2018 IEEE International Conference on Acoustics, Speech and Signal Processing (ICASSP), 2018, pp. 2616-2620], the probability that the model correctly estimated a certain φi is given by,

$${P}_{{ϕ}_{i}} = \frac{{N}_{c , {ϕ}_{i}}}{{N}_{{ϕ}_{i}}} , \qquad ( 13 )$$

where Nφi is the number of noise bursts in the test set with a DOA of φi, and Nc,φi is the number of those bursts that were correctly estimated by the model. An estimate was deemed correct if it was within ±Δφ of the ground truth incident angle. The average probability of correct estimation over all φi in the test set was used to determine a model's broad accuracy.

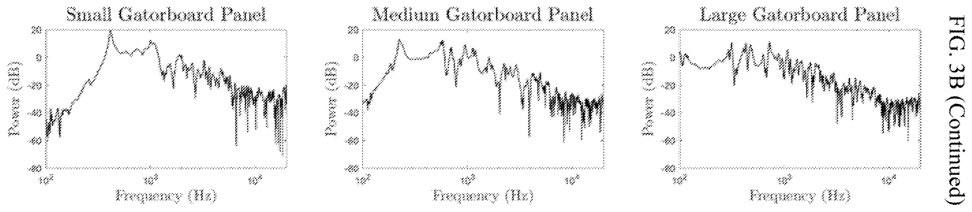

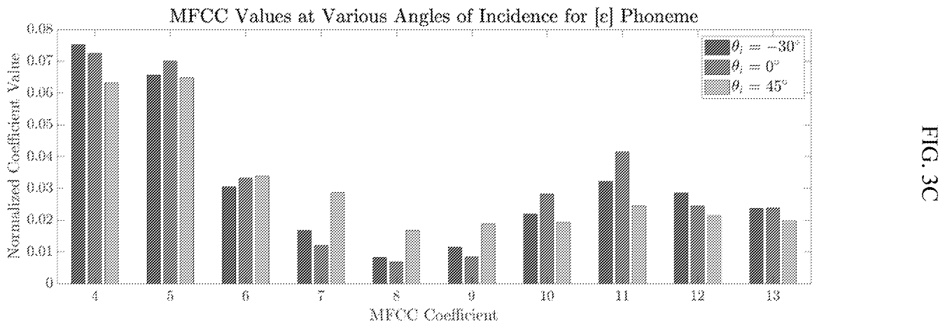

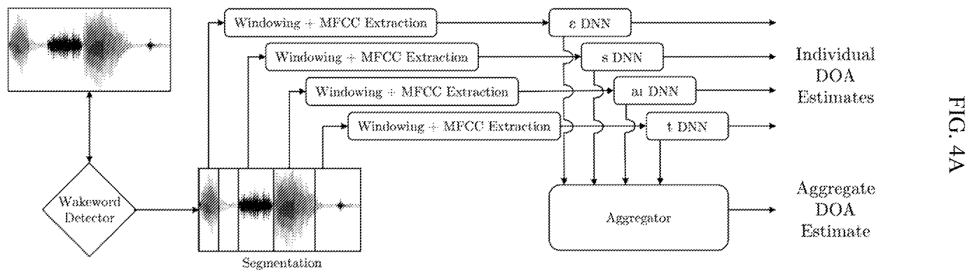

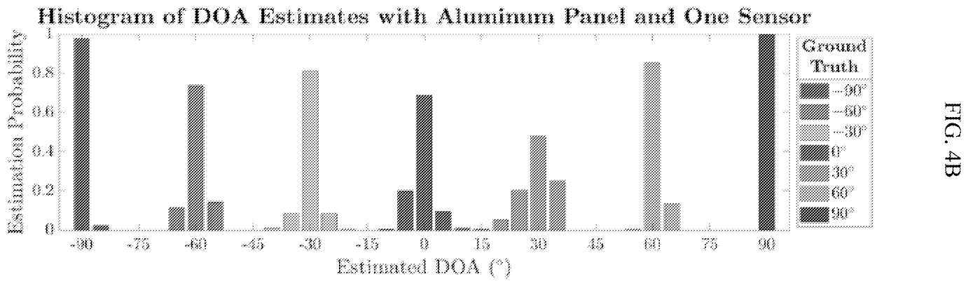

The DOA estimation for the testing set using N=1 sensor is displayed in the histogram in FIGS. 4B and 4C with a bin size of 5°. This histogram demonstrates that estimation errors are distributed in bins adjacent to the ground truth angle, even when using a single structural sensor.

The estimation accuracy for angular tolerances of Δφ=1° and Δφ=5° at each incident angle is for different values of N. With Δφ=1°, the disparity between models trained with N sensors is more pronounced. Increasing the number of sensors generally resulted in improved estimation accuracy.

By increasing Δφ from 1° to 5°, the models scored significantly higher across all angles in the test set. This further demonstrates that estimation errors are tightly distributed around the correct angle. For an angular tolerance of 5°, all models trained with more than one sensor perfectly predicted the ground truth DOA. This is shown in Table 5, which gives the average probability of correct DOA estimates across all angles. It should be noted that for Δφ≥10°, a single sensor is sufficient for perfect classification under the experimental conditions.

TABLE 5
Tabulated are the validation RMSEs and the average reliability of the DOA
estimates made by the DNNs trained with broadband noise using both the
convolution and recording approaches when acting on their respective testing
sets, with the results from the recording approach italicized. The tabulated results
are those given by the models with the best validation RMSE for each value of N.

| | | | | Reliability (%) to within: | | | | | |
|---|---|---|---|---|---|---|---|---|---|
| Material | N | RMSE (°) | | ±5° | ±10° | ±20° | ±5° | ±10° | ±20° |
| Acrylic | 1 | 0.909 | 1.08 | 99.8 | 99.9 | 99.9 | 99.8 | 99.9 | 99.9 |
| | 3 | 0.601 | 0.483 | 100 | 100 | 100 | 100 | 100 | 100 |
| | 5 | 0.377 | 0.261 | 100 | 100 | 100 | 100 | 100 | 100 |
| Al. Sandwich | | 2.84 | 3.52 | 93.3 | 99.1 | 99.9 | 89.7 | 98.3 | 99.8 |
| | 3 | 1.36 | 1.24 | 99.9 | 100 | 100 | 100 | 100 | 100 |
| | 5 | 1.13 | 1.06 | 100 | 100 | 100 | 100 | 100 | 100 |
| Gatorboard | | 2.41 | 2.82 | 98.9 | 99.9 | 99.9 | 99.9 | 99.7 | 99.8 |
| | 3 | 1.03 | 0.802 | 100 | 100 | 100 | 100 | 100 | 100 |
| | 5 | 0.547 | 0.479 | 100 | 100 | 100 | 100 | 100 | 100 |

The data set for this experiment was gathered in a semi-anechoic environment. In addition, the signals used for this experiment were 100 millisecond stationary noise bursts. As DOA is often an important parameter for speech signal processing algorithms, the transient nature of elements of speech signals may call for the use of array-based algorithms such as GCC-PHAT modified for multiple structural sensors affixed to a single panel. This work experimentally demonstrates that DOA estimates with +/−5° accuracy can be made using a single structural sensor mounted on a compliant surface.

### Example 3: Systems and Methods for Capturing Sound Using Structural Vibration Sensors

A structure employing several vibration sensors can determine direction of arrival of sound by using an array of vibration sensors. However, if the structure has a multimodal response within the bandwidth of the excitation signal, only a single sensor is needed to determine the direction of arrival. Each mode has a unique spatial response, and those responses are excited with different amplitudes depending on the angle of the acoustic wave incident on the surface. A neural network can be trained using features such as Mel-frequency Cepstral Coefficients (MFCCs), or any other features that are sensitive to amplitude changes in different frequency bands, to identify differences in the relative modal excitations, and match them to a particular incident angle for the source. The differences between MFCC's for several different incident angles are shown in FIG. 3C.

A machine learning model trained on a panel affixed with one vibration sensor correctly predicts the direction of an incoming acoustic wave (white noise) to within five degrees of the true angle with an accuracy of 93.3%-99.8% and to within ten degrees of the true angle with an accuracy of 99.1%-99.9% depending on the panel's material properties. When two or more sensors are placed on the panel, the machine learning model correctly predicts the direction of an incoming acoustic wave containing white noise to within five degrees of the true angle with an accuracy of 100%. This result is significant because typically, determining the direction-of-arrival requires arrays of multiple conventional microphones. The resonant modes of a structure allow an accurate determination of the direction-of-arrival to be made using a single vibration sensor.

In practical applications, the acoustic waves incident to the device contain speech, which has a limited bandwidth compared to white noise. As these devices commonly use wake-words, a neural network can be trained to estimate the direction of arrival from frames containing each individual part of speech. Consider a potential wake-word “excite”, which contains five distinct speech sounds: a vowel “ch” (or [ε] in the International Phonetic Alphabet), a velar stop “k” (or [k′]), a fricative “s” (or [s]), a diphthong “ai” (or [aI]), and a plosive “t” (or [t]). An algorithm for estimating the direction of arrival of a speech source saying “excite” may utilize one or many of those speech sounds, and an example algorithm is shown in FIG. 4.

To see the effect of the bandlimited nature of speech sounds, the accuracy with which a trained neural network can estimate the direction of arrival from the individual speech sounds is compared to that of broadband white noise in Table 7.

TABLE 6
Probability with which a trained neural network estimates the direction of arrival of a speech
wave containing white noise as well as the individual speech sounds in the word ″excite″.
N refers to the number of sensors affixed to the panel and used in training and testing.

| | | White Noise | | | [ai] | | | [ε] | | |
|---|---|---|---|---|---|---|---|---|---|---|
| | | Probability of Correct Estimate to within: | | | | | | | | |
| Material | n | ±5° | ±10° | ±20° | ±5° | ±10° | ±20° | ±5° | ±10° | ±20° |
| Acrylic | 1 | 0.998 | 0.999 | 0.999 | 0.762 | 0.921 | 0.972 | 0.752 | 0.928 | 0.978 |
| | 3 | 1.00 | 1.00 | 1.00 | 0.976 | 0.995 | 0.998 | 0.98 | 0.999 | 1.00 |
| | 5 | 1.00 | 1.00 | 1.00 | 0.988 | 0.998 | 1.00 | 0.983 | 0.997 | 0.999 |
| Aluminum | 1 | 0.933 | 0.991 | 0.999 | 0.658 | 0.877 | 0.971 | 0.664 | 0.874 | 0.968 |
| | 3 | 0.999 | 1.00 | 1.00 | 0.985 | 1.00 | 1.00 | 0.986 | 1.00 | 1.00 |
| | 5 | 1.00 | 1.00 | 1.00 | 0.982 | 1.00 | 1.00 | 0.992 | 1.00 | 1.00 |
| Gatorboard | 1 | 0.989 | 0.999 | 0.999 | 0.865 | 0.960 | 0.984 | 0.745 | 0.909 | 0.958 |
| | 3 | 1.00 | 1.00 | 1.00 | 0.993 | 0.996 | 0.998 | 0.978 | 0.998 | 1.00 |
| | 5 | 1.00 | 1.00 | 1.00 | 0.998 | 0.999 | 1.00 | 0.983 | 1.00 | 1.00 |

| | | [t] | | | [s] | | |
|---|---|---|---|---|---|---|---|
| | | Probability of Correct Estimate to within: | | | | | |
| Material | | ±5° | ±10° | ±20° | ±5° | ±10° | ±20° |
| Acrylic | 1 | 0.754 | 0.926 | 0.982 | 0.821 | 0.955 | 0.987 |
| | 3 | 0.988 | 0.999 | 1.00 | 0.999 | 1.00 | 1.00 |
| | 5 | 0.989 | 1.00 | 1.00 | 0.999 | 1.00 | 1.00 |
| Aluminum | 1 | 0.513 | 0.790 | 0.960 | 0.697 | 0.926 | 0.992 |
| | 3 | 0.99 | 1.00 | 1.00 | 0.960 | 0.999 | 1.00 |
| | 5 | 0.998 | 1.00 | 1.00 | 0.999 | 1.00 | 1.00 |
| Gatorboard | 1 | 0.653 | 0.868 | 0.953 | 0.747 | 0.95 | 0.984 |
| | 3 | 0.959 | 0.999 | 1.00 | 0.995 | 1.00 | 1.00 |
| | 5 | 0.982 | 1.00 | 1.00 | 0.995 | 1.00 | 1.00 |

Table 6 above demonstrates that a singular sensor affixed to a panel can estimate the direction of arrival of bandlimited speech sounds to within five degrees of the true angle with an accuracy of up to 86.5%, and to within ten degrees of the true angle with an accuracy of up to 96.0%, depending on the panel's material properties and the speech sound the network is trained to handle. In preferred embodiments, improved results are obtained by optimizing the feature set for the particular panel in use. Adding one or more additional sensors allows for the direction of arrival to be estimated to within five degrees of the true angle with up to 100% accuracy.

### Example 4: Systems and Methods for Cross-Talk Cancellation on a Flat-Panel Smart-Speaker

One problem that could arise when employing a vibrating surface as both a loudspeaker and microphone simultaneously is that the vibration sensor used to detect speech inputs will inevitably record the surface vibrations induced by the loudspeaker actuators. Vibrations from affixed actuators more efficiently drive the panel's surface than induced vibration from incident plane waves. Therefore, the sensor will observe a larger contribution from the actuators than from the incident sound waves even if both signals contain the same input power. This problem of simultaneous playback and recording also affects existing smart audio devices, though on these devices, microphones record both signals as acoustic pressure variations in air, therefore neither has a coupling advantage to the microphone.

Because the panel is operating in a linear deflection region, subtraction approaches can be used to directly cancel the audio from actuators provided the transfer function from the actuator to the sensor h2[n] is known. In general, this transfer function can be obtained at the time of device assembly as the actuator will never move once it is affixed to the panel's surface. The signal being played by the actuators x[n] is known, as it is determined by device's the audio reproduction system. The acoustic source signal s[n] filtered by the acoustic transfer function h1[n] from the source to the sensor affixed to the surface of the panel may be isolated by subtracting x[n] filtered by h₂[n] from the sensor response z[n] given by,

$$z [ n ] - x [ n ] \text{?} {h}_{2} [ n ] = s [ n ] \text{?} {h}_{1} . \qquad ( 1 )$$

Transfer function h₂[n] in (1) above may be understood as a delay in sequence with a finite impulse response (FIR) filter such that,

$$z [ n ] - x [ n ] \text{?} {h}_{2}^{′} [ n - {p}_{d} ] = s [ n ] \text{?} {h}_{1} . \qquad ( 2 )$$

where h′2[n] contains the harmonic information from h2[n] as an FIR filter with non-zero first tap and p_{d} represents the total delay from the time a sample is played via the actuator to when its response is recorded including propagation delay on the panel's surface and any hardware delays. A precise value for p_{d} is important if subtraction is to be done in discrete time, though spectral subtraction on a frame level may reduce sensitivity to slight drifting of the true value of p_{d}.

The spectrogram of acoustic waves containing a passage of speech recorded by a panel with no contribution from an affixed actuator is shown in FIG. 5. When the panel records signals that contain contributions from both incident waves and the affixed actuator, the spectrogram shown in FIG. 5 becomes the target spectrogram when applying the cancellation algorithm. Spectrograms showing this dialog snippet in a mixture with the white noise, classical music, and synthesized speech being played by the actuators are shown in FIGS. 6-8. Quantitative results regarding post-cancellation SNR improvement among all panels are tabulated in Table 5 above.

In general, the subtraction has a large impact on the SNR of the audio stream. SNR increased an average of 51.1 dB among aluminum panels, 40.1 dB among acrylic panels, and 39.3 dB among gatorboard panels. This shows a similar trend to the WER metric results from Table 7, in that more highly damped panels show better reliably in can—celling the actuator's contribution to the audio stream. All SNR improvements reported in Table 5 above show the feasibility of removing the highly-coupled actuator contribution to the audio stream.

### Example 5: Systems and Methods for Capturing Touch Inputs Using Structural Sensors

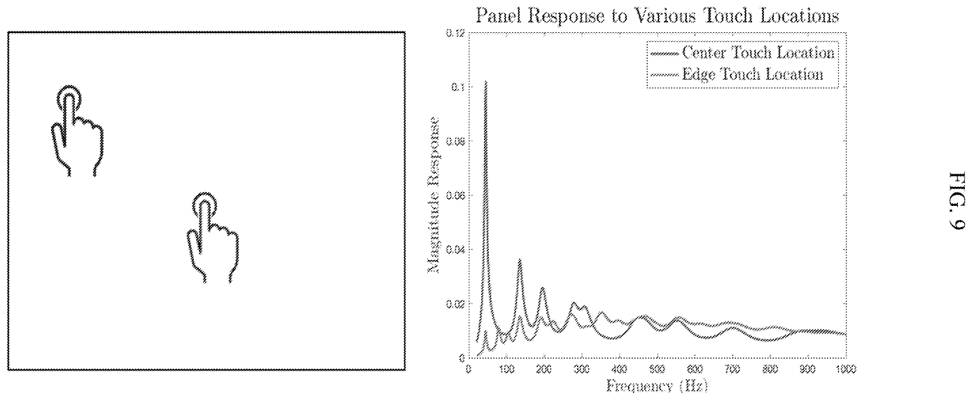

In a similar way, the vibration sensors may also be used to determine information about touch inputs on the surface of the structure. For example, the sensor data may be used to determine where the structure was touched, and with what force. As each location on the structure's surface is uniquely coupled to each of the resonant modes, the relative modal excitations will be different for each touch location. This is shown in FIG. 9, which gives the simulated response of a panel to two different touch locations. With a central touch location, fewer modes are excited than when the panel is touched nearer to its edge, but those that are excited have a stronger relative excitation.

Touching the surface of an elastic object changes the boundary conditions, i.e., it impedes the motion of the object at the point of touch, which then changes the resulting response. This is similar to what happens when a player lightly touch a guitar string at various locations and then plucks it to create harmonic signals. The resulting vibrations are a function of where the player touches the string, thereby keeping it from vibrating at the touch point.

The touch input may be detected “actively”, or “passively”. In active touch sensing, the surface is excited by an actuator playing a known signal. A sensor affixed to the panel records the input and looks for deviations from the known signal. Each deviation corresponds to a particular touch location/gesture. In passive touch sensing, the sensor is affixed to the surface and looks for different vibration inputs.

### Example 6—Estimating Acoustic Direction of Arrival Using a Single Structural Sensor On a Resonant Surface

Experimental results show that when all thirteen of an acrylic panel's isolated modal bands are utilized, the DOA of incident acoustic waves for a broadband noise signal may be estimated by a single structural sensor to within ±5° with a reliability of 98.4%. The size of the feature set may be reduced by eliminating the resonant modes that do not have strong spatial coupling to the incident acoustic wave. Reducing the feature set to the seven modal bands that provide the most spatial information produces a reliability of 89.7% for DOA estimates within ±5° using a single sensor.

Sensors are affixed to an acrylic panel and used to record acoustic noise signals at various angles of incidence. From these recordings, feature vectors containing the sums of the energies in the panel's isolated modal regions are extracted and used to train deep neural networks to estimate DOA.

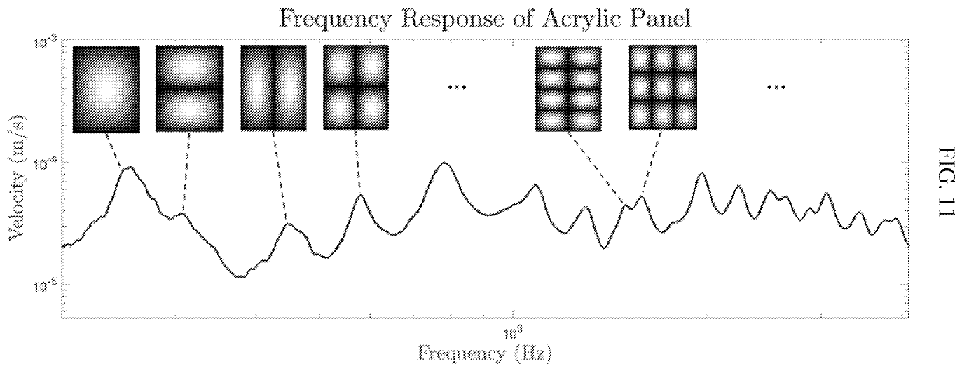

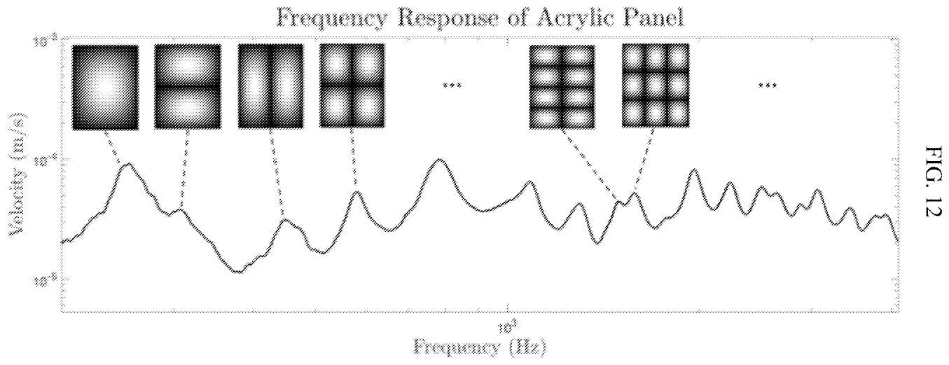

A 2 mm thick acrylic panel with E=3.2 GPa, v=0.35, ρ=1, 180 kg/m³, and (Lₓ, L_{y})=(18 cm, 23 cm) was constructed. The panel's spatially-averaged velocity response with corner excitation was measured using a Polytec PSV-500 scanning laser vibrometer and plotted in FIG. 11 to show the modes of the panel that would be excited by incoming acoustic waves.

The panel was mounted in a semi-anechoic space to a rotary table capable of rotating between √i=−90° and 90° In 5° increments relative to a KEF LS50 loudspeaker placed on-axis at a distance of one-half meter. At each angle of incidence, the panel was excited by 1,800 broadband noise bursts from the loudspeaker, each with a duration of 100 ms, and the panel's response was recorded by a single PCB Piezotronics U352C66 accelerometer arbitrarily positioned off-center in each dimension.

The vibrometer scan shown in FIG. 11 was used to determine the center frequencies and bandwidths of the isolated modal bands in the panel's vibration response. Note that some bands may contain degenerate modes, such as the band containing the (2, 4) and (3, 3) modes. At sufficiently high frequencies, so many modes are excited simultaneously that individual modes can no longer be observed in the panel's response. For this panel, this effect occurs at approximately 4 kHz, so the response above this frequency may be ignored. The thirteen isolated modal bands below this threshold were used to make a band-pass filter bank Gₗ with center frequencies f_{c} and bandwidths Δf shown in Table 8. The modes contained in isolated modal bands with significant degeneracy are labeled “unclear” in the table. The energy contained in the l^{th} band, E(l), can be computed by,

$$E ( l ) = {\int }_{ω} {G}_{l} {\vert S ( j ω ) \text{?} ( j ω ) \vert}^{2} d ω ,$$

$$\text{?} \text{indicates text missing or illegible when filed}$$

where S(jω) and H_{θi}(jω) are the Fourier transforms of s(t) and h_{θi}(t) respectively. The proposed feature vector is an array containing E(l) values for the recorded panel vibrations. The filter bank may be abbreviated to contain only the bands with modes whose excitation varies strongly with θᵢ, as these modes are hypothesized to be the most useful for determining DOA. Algorithm 1 shows how is used to rank modes by variance in θi.

$${α}_{r} = \frac{{p}_{r} ( {θ}_{i} , ω )}{ρ h ( {ω}_{r}^{2} - {ω}^{2} + j {ω}_{r} ω / {Q}_{r} )} , \qquad ( 7 )$$

ALGORITHM 1
Pseudo-code for selecting modes with the
greatest excitation variance with respect to θᵢ

| | |
|---|---|
| 1: | for all isolated modes r do |
| 2: | for all angles θᵢ in dataset do |
| 3: | Compute αᵣ at θᵢ using (7) |
| 4: | end for |
| 5: | Normalize resulting αᵣ values |
| 6: | Compute variance of normalized αᵣ values |
| 7: | end for |
| 8: | Rank modes r by greatest variance when varying θᵢ |

The deep neural networks (DNNs) used in this work are LSTM-based recurrent neural networks modeled after networks that have shown promise in classifying colors of broadband noise from spectral features, modified in this case to estimate DOA using these energy-sum feature vectors with thirteen or fewer values of E(l). A set of 37,000 broadband noise bursts across all considered θi were used to excite the panel, and the recorded vibration responses were split into training and validation sets with a ratio of 80:20. An additional 29,600 responses were recorded as a testing set. The DNNs were trained with a loss function that minimizes the root-mean-square error between the known incident angle and the estimate returned by the model using regression. When acting on the testing set, the reliability of each DNN was determined by its ability to estimate DOA within an angular tolerance of ±Δθ as the ratio of the number of correct predictions within the ±Δθi to the total number of bursts in the set whose incident angle was θi. Angular tolerances Δθ of 5°, 10°, and 20° were used.

The DNN trained with each of the thirteen isolated modal bands estimated DOA to within ±5° with a reliability of 98.4% as shown in Table 7 below (Reliability of the DOA estimates made by DNNs trained with subsets of the resonance-informed filter bank. Bands are removed in the leftmost columns by least excitation variance when varying θi, and removed by most variance in the italicized rightmost columns).

TABLE 7

| # | Reliability of DOA Estimates to within: | | | | | |
|---|---|---|---|---|---|---|
| Bands | ±5° | ±10° | ±20° | ±5° | ±10° | ±20° |
| 13 | 0.984 | 1 | 1 | | | |
| 12 | 0.978 | 1 | 1 | 0.981 | 1 | 1 |
| 11 | 0.962 | 0.998 | 1 | 0.977 | 0.999 | 1 |
| 10 | 0.966 | 0.998 | 1 | 0.966 | 0.999 | 1 |
| 9 | 0.945 | 0.993 | 1 | 0.917 | 0.991 | 0.995 |
| 8 | 0.921 | 0.993 | 0.998 | 0.880 | 0.984 | 0.994 |
| 7 | 0.897 | 0.983 | 0.998 | 0.836 | 0.958 | 0.974 |

The abbreviated versions of the resonance-informed filter bank can be used without significant reduction in reliability, particularly when removing bands that contain modes with the smallest excitation variance with respect to θi. A DNN trained using as few as seven modal bands was able to estimate DOA to within with a reliability of 89.7%.

Modes whose amplitudes vary significantly with the incident angle are more effective for DOA estimation. Since several of the reported isolated modal bands contained significant degenerate modes, only 8 of the 13 bands could be ranked directly with Algorithm 1. In future work, Algorithm 1 may rank the variance of E(l) directly using empirical data. Additionally, the sensor couples better to certain modes depending on its location relative to the mode's nodal lines. An optimal sensor location based on the panel's resonances should be determined to ensure that the sensor has strong coupling to all the modes within the isolated bands.

Compact feature vectors informed by the resonant properties of a panel surface are sufficient for reliable DOA estimation using a single structural sensor. The method presented is a more efficient approach to DOA estimation utilizing surface vibrations, and is an important step in the design of panel-based smart audio devices.

### Example 7—Neural Networks Estimate DOA from Recordings of Both Broadband Noises and Speech Phonemes

Mel-frequency cesptral coefficients (MFCCs) are a compact representation of the frequency range associated with the human auditory system (~20 Hz to 20 kHz). MFCCs are generally derived by passing an audio signal through a filter bank of 40* bandpass filters whose center frequencies are spaced according to their prevalence in the human auditory system. The energy contained in each of these bands is summed, and the discrete cosine transform is used to transform this energy vector of 40* values into a compact, 13* element feature vector.

The elements contained in an MFCC feature vector essentially represent the sum of the energy contained in various bandwidths in the frequency response of an audio signal. For this reason, MFCCs may be able to reveal information about the relative amplitudes of the panels modes, although with several layers of abstraction. MFCC feature vectors that are derived from recordings of panel vibrations vary with the incident angle of the excitation signal (FIG. 3C). Therefore, the elements of an MFCC feature vector contain spatial information useful for estimating DOA (see Table 6 for broadband excitation; Table 7 for phonetic excitation).

Five distinct DNNs were trained: one for estimating DOA from incident broadband noise bursts and four for estimating the DOA from incident bursts containing each individual usable phoneme in the word “excite” (omitting the velar ejective stop). The training data for each DNN is noise or speech bursts convolved with the panel's impulse responses for each rotational angle. Each DNN is trained with 185,000 total bursts (1000 per angle over five sensors) that were split into training and validation sets with a ratio of 80:20. An additional 148,000 bursts (800 per angle over five sensors) were used to test the performance of each DNN. The broadband noise bursts are snippets of independently generated white noise. For the phoneme data, a single male speaker recorded each individual usable phoneme in isolation 1800 times such that the training, validation, and testing sets could be sufficiently populated. The speaker slightly varied volume and pronunciation while performing each phoneme for a degree of robustness on a speaker-dependent level.

MFCC vectors were extracted from each burst in the training and validation sets. During training and testing, each structural sensor was in either an ‘on’ or ‘off’ state, whereby the DNN model either utilized the data vectors from that sensor or ignored them entirely. The study defined N as the number of sensors that were ‘on’ while training a particular model. For each class of DNN, 31 total models were trained corresponding to the number of unique sensor combinations out of the 5 affixed sensors, ranging from models utilizing a single sensor (N=1) to a model that utilizes data from all sensors (N=5). Models were trained with the loss function L_{RMSE} that minimizes the root-mean-square error (RMSE) between the known incident angle θi and the incident angle θ^{e}ᵢ estimated by the model, where L_{RMSE} is given by,

The models were evaluated by their ability to make correct estimates of the incident angle within a defined angular tolerance. An estimate was deemed correct if it was within ±Δθ of the known incident angle. The reliability with which the model correctly estimates the DOA at each angle θi is given as the ratio of the number of correct predictions within ±Δθi to the total number of bursts tested whose incident angle is known to be θi. The average reliability with which the DNNs estimated the incident angle of the bursts in the test sets are measured for a Δθ of 5°, 10°, and 20°.

Tabulated in Table 8 are the validation RMSEs and the reliability of the DOA estimates made by the DNNs trained with broadband noise using both the convolution and recording approaches when acting on their respective testing sets, with the results from the recording approach italicized. The tabulated results are those given by the models with the best validation RMSE for each value of N.

TABLE 8

| | | Validation | | Reliability of DOA Estimates to within: | | | | | |
|---|---|---|---|---|---|---|---|---|---|
| Material | N | RMSE (°) | | ±5° | ±10° | ±20° | ±5° | ±10° | ±20° |
| Acrylic | 1 | 0.909 | 1.08 | 0.998 | 0.999 | 0.999 | 0.998 | 0.999 | 0.999 |
| | 3 | 0.601 | 0.483 | 1.00 | 1.00 | 1.00 | 1.00 | 1.00 | 1.00 |
| | 5 | 0.377 | 0.261 | 1.00 | 1.00 | 1.00 | 1.00 | 1.00 | 1.00 |
| AL Sandwich | 1 | 2.84 | 3.52 | 0.933 | 0.991 | 0.999 | 0.897 | 0.983 | 0.998 |
| | 3 | 1.35 | 1.24 | 0.999 | 1.00 | 1.00 | 1.00 | 1.00 | 1.00 |
| | 5 | 1.13 | 1.05 | 1.00 | 1.00 | 1.00 | 1.00 | 1.00 | 1.00 |
| Gator Board | 1 | 2.41 | 2.82 | 0.989 | 0.999 | 0.999 | 0.993 | 0.997 | 0.988 |
| | 3 | 1.03 | 0.802 | 1.00 | 1.00 | 1.00 | 1.00 | 1.00 | 1.00 |
| | 5 | 0.547 | 0.478 | 1.00 | 1.00 | 1.00 | 1.00 | 1.00 | 1.00 |

In the first experiment, a DNN was trained to estimate the direction of arrival of broadband noise bursts. Two distinct training, validation, and testing sets were created: one where the noise bursts were convolved with the measured transfer function from the speaker to the vibration sensor at each angle of incidence, and one where the noise bursts were directly recorded at each angle by the structural sensor. For both the convolved and recorded data sets, a DNN was trained using each possible combination of the five affixed sensors, and the model that yielded the smallest validation RMSE for N=1, 3, and 5 was applied to the testing set. For these trained models, the validation RMSE during training and the average reliability of their DOA estimates when they acted on the testing set is shown in Table 8.

The results show evidence of the potential for a DNN to reliably estimate the incident angle of broadband noise bursts with as few as one structural sensor. A DNN trained with data from a single sensor on the acrylic panel estimated the DOA of the bursts in the testing set to within ±5° up to 99.8% of the time. A DNN trained with data from a single sensor on the Gatorboard panel estimated the DOA of the bursts in the testing set to within ±5° up to 99.3% of the time. On the more highly damped Al. sandwich panel, a DNN trained with data from a single sensor estimated the DOA of the bursts in the testing set to within +5° up to 93.3% of the time. It is also worth noting that for all panel materials, utilizing information from additional sensors increases the reliability of the DOA estimates within +5° to 100%. The distributions of estimates made by the DNNs trained with data from a single sensor on the Al. sandwich and acrylic panels for bursts at selected angles of incidence in the testing set were measured (see FIGS. 4B, 4C). For the Al. sandwich panel, the majority of estimates (79%) fall within the correct bin and only 1.57% of estimates fall outside of the bins directly adjacent to the correct bin. When the acrylic panel is used, the histogram shows a near-perfect distribution of estimates with 99.2% of estimates falling in the correct bin. The reduction in reliability from the acrylic and Gatorboard panels to the Al. sandwich panel demonstrates the trade-off damping presents: while the intelligibility of recorded vibration signals is moderately improved by utilizing more highly-damped panels, the modal and reverberant properties of the panel yield spatial information pertinent to DOA estimation.

The reduction in validation and testing reliability between the acrylic and Gatorboard panel may also suggest that there is an upper limit to the improvement in DOA estimation reliability that may come with a reduction in damping. This may be due to a greater amount of audio smearing from very high-Q modes. However, it may only suggest that the center frequencies of the mel filter bank more closely relate to the acrylic panel's modes than those of the Gatorboard panel. The use of an optimal filter bank informed by the resonances of the panel is another embodiment.

From Table 8, the largest disparity in validation RMSE during training between the convolved and recorded datasets was 0.68°. When the DNNs acted on their respective training sets, the largest disparity in the reliability of their DOA estimates to within ±5° was 3.57%. Therefore, the convolution approach to training and testing DNNs with phonetic bursts can be utilized without diminishing accuracy.

In the second experiment, four distinct DNNs were trained using recordings of the usable phonemes in the word “excite”. The corpus of recordings of the individual phoneme sounds was convolved with the measured transfer function from the speaker to the vibration sensor at each angle of incidence. As with the previous experiment, a DNN was trained using each possible combination of the five affixed sensors, and the model with the smallest validation RMSE for N=1, 3, and 5 was applied to the testing set. The average reliability of the DOA estimates made by the trained DNN models when they acted on the phonetic testing sets was measured.

Using a single sensor on the acrylic panel, the DNN correctly estimated the DOA of the bursts in the testing sets to within ±5° greater than 75% of the time for each phoneme. When extending Δθ to 10°, the DNN correctly estimated the DOA of the bursts in the testing sets greater than 92% of the time. DNNs trained using a single sensor on the Gatorboard panel yielded comparable reliability when estimating DOA over the phonetic testing sets. Once again, the acrylic and Gatorboard panels generally outperformed the highly-damped Al. sandwich panel, though the Al. sandwich panel was still able to correctly estimate the DOA of the bursts in the testing sets to within ±10° greater than 79% of the time across the tested phonemes, including 92.6% of the time for the[s] phoneme which most closely resembles broadband noise. Though the experiment is limited in nature by the use of speech from a single speaker in an anechoic environment, the results suggest that the DOA of speech sources may be estimated by a single sensor on a panel. Once again, it worth noting that utilizing information from additional sensors increases the reliability of the DOA estimates within ±5° to greater than 95% across all the tested panel materials and phonemes.

The DOA estimation algorithm is more efficient if a single DNN could be used to estimate DOA from all four phonemes in the wake-word. A well trained DNN with data from a particular sound can estimate the DOA of a different speech sound. Each of the DNNs trained utilizing a single sensor on the acrylic panel is applied to the testing sets containing the other tested speech sounds. The resulting matrix shows estimation reliability within ±10° for this experiment. In general, DNNs trained with phonemes of similar quality (such as the pair of [aI] and [E] or the pair of [t] and [s]) are able to more reliably estimate DOA than DNNs trained with phonemes of dissimilar quality. It is worth mentioning that the DNN trained with broadband noise bursts does a poor job generalizing to all phonemes despite intuition that it may perform well when applied to speech sounds [s] and [t]. This is likely because “the source” in the source-filter model of human speech more closely resembles pink noise than white noise. In future work, a human “source” signal may be used to see if a DNN trained with this type of noise generalizes better to speech sounds.

While the results do not demonstrate that a single DNN trained in this work can be used to estimate the DOA of any of the tested speech sounds without loss in reliability, it may be possible to reduce the number of DNNs needed for the aggregate DOA estimator by grouping speech sounds of similar quality. Another option is training a model to efficiently estimate DOA from the waveform of a wake-word in its entirety.

The results discussed herein are considered speaker-dependent as the DNNs were trained using the speech sounds of a single male speaker. To see how well these DNNs can be used to estimate DOA from the speech sounds of a different speaker, a female speaker recorded a second testing set for each phoneme. The difference in the reliability of the DOA estimates made by the trained DNNs when they acted on the testing sets made by the primary male speaker and by the secondary female speaker is shown. The models did not appear to generalize well to the female speaker, with a reduction in the probability of correct DOA estimate of up to nearly 70%. This is likely due to resonance disparities of “the filter” in the source-filter model of human speech between the two speakers. Another embodiment is training a model to handle human speech in general.

Another embodiment is reducing the number of DNNs by grouping speech sounds of similar quality. And while the DNN trained with broadband noise bursts does a poor job estimating the DOA of the tested phonemes, using a DNN trained with true human “source” signals for this task will be explored in future work. Additionally, a DNN distinct from those employed in this work may be trained to efficiently estimate DOA from the waveform of a wake-word in its entirety.

### Example 8—Use of a Filter Bank Whose Frequencies are Determined by the Resonant Frequencies of the Base Surface

The spatial information contained in a panel's modes may be more efficiently extracted using the presented energy summing technique utilizing a filter bank whose center frequencies match the specific resonant frequencies of each panel. This also enables the rejection of the contributions of those frequency bands that do not contain spatial information, reducing the size of the feature vectors that are used by the DNNs to increase computational efficiency. Obtaining an optimized feature vector via energy-summing distinguishes this approach from others.

The frequency range containing a panel's isolated resonances cuts off at a significantly lower frequency (~2 kHz) than the human auditory system (~20 kHz) as shown in FIG. 12. Note that this measurement is an example from only one panel and as such this response will not characterize panels in general. However, the panel's isolated resonances being observable in low-frequency regions of the panel's frequency response is a general characteristic of these vibrations. Therefore, the use of MFCCs to represent the relative excitation of panel modes may be inefficient, as they give information about a wider bandwidth than is necessary.

The study has demonstrated more efficient feature vectors can be derived by using direct measurements of the resonant frequencies and bandwidths of the panel's isolated modes. The following Table 9 (which represents a specific panel) shows the center frequencies and bandwidths of the isolated resonances of the acrylic panel whose response was depicted above:

TABLE 9

| | f_{c} (Hz) | Δf (Hz) | Mode(s) |
|---|---|---|---|
| Band 1 | 256.5 | 60.0 | (1, 1) |
| Band 2 | 454.9 | 115 | (1, 2) |
| Band 3 | 582.7 | 88.6 | (2, 1) |
| Band 4 | 784.2 | 146 | (2, 2) |
| Band 5 | 1168 | 312 | (2, 3) |
| Band 6 | 1287 | 210 | (3, 2) |
| Band 7 | 1564 | 340 | (2, 4), (3, 3) |
| Band 8 | 1962 | 224 | Unclear |
| Band 9 | 2233 | 317 | (4, 3) |
| Band 10 | 2554 | 666 | Unclear |
| Band 11 | 3028 | 707 | Unclear |
| Band 12 | 3430 | 506 | Unclear |
| Band 13 | 3832 | 900 | Unclear |

The resonant frequencies and bandwidths of a panel's modes can therefore be used to make a filter bank of bandpass filters. The energy in each of the bands can be summed after applying the filter bank to make a feature vector. A model trained with a filter bank described in the above table was able to estimate the DOA of broadband noise excitation signal to within plus or minus 5 degrees with a reliability of 98.4%.

### Example 9—Estimating the Direction of Arrival of a Spoken Wake Word Using A Single Sensor on an Elastic Panel

“Edge devices” have feature sets and neural network architectures that are hardware-optimized with spectrally-rich features, such as mel and linear spectrograms and short-time Fourier transforms (STFTs) (e.g., Syntiant's tiny machine learning (TinyML) development board is a commercially available edge device that features an always-on neural decision processor (NDP) for performing wake word detection and other real-time speech processing tasks). As these features contain information about the entire spectrum of the recording, they will contain information about the relative excitation of the panel's modes. As with the MFCCs, this is a theoretically inefficient feature vector, though in many cases the hardware of these edge devices is optimized to use these larger feature vectors.

The study recorded a male and a female speaker saying the trigger phrase “hey Alexa” 300 times each. These recordings were played to an acrylic panel that was equipped with a single structural vibration sensor as it was rotated through an angular range from −90 to 90 in 5 increments. This resulted in 11,100 recordings per participate over 37 different angles of incidence.

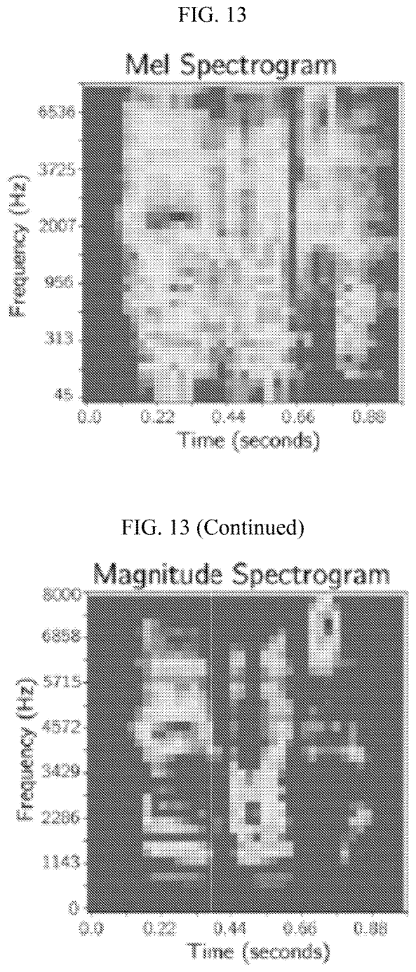

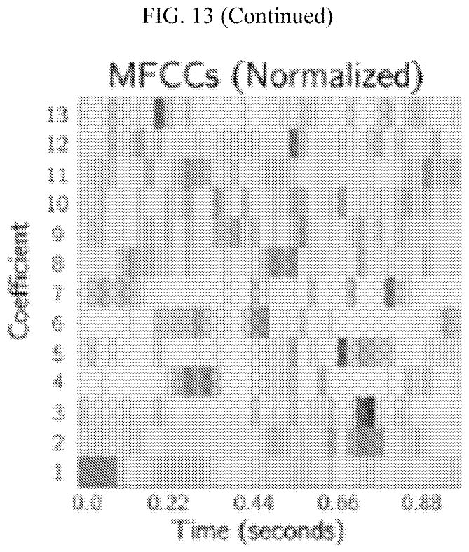

Mel and magnitude spectrograms were extracted from each of the recordings, and used to train two distinct neural network architectures that are both compact enough to be embedded onto an edge device. Examples of these feature vectors that contain spectral information regarding the panel's response to an excitation signal containing the words “hey Alexa” are shown in FIG. 13.

Experimental results demonstrated that the models trained with these features were able to reliably estimate the DOA of the trigger phrase. These results are tabulated below in Table 10 for the models trained with speech recorded by the panels from both the male and female participants.

TABLE 10

| | | Reliability (%) to within: | | | | | |
|---|---|---|---|---|---|---|---|
| Network | Feature | ±5° | ±10° | ±20° | ±5° | ±10° | ±20° |
| CNN | MFCC | 89.1 | 99.3 | 100 | 82.5 | 98.3 | 99.7 |
| | Mel-Spect | 92.7 | 99.4 | 100 | 92.9 | 99.5 | 100 |
| | Mag-Spect | 97.1 | 99.8 | 100 | 98.3 | 99.9 | 100 |
| RNN | MFCC | 82.2 | 97.3 | 99.7 | 78.9 | 96.7 | 99.5 |
| | Mel-Spect | 94.3 | 99.9 | 100 | 87.9 | 99.6 | 100 |
| | Mag-Spect | 76.7 | 96.7 | 99.8 | 82.7 | 99.2 | 100 |
| | Syntiant | 99.7 | 100 | 100 | 99.9 | 100 | 100 |

| | | |
|---|---|---|
| Voice | Male | Female |

The present application encompasses the use of any feature set that can encode spectral information regarding the relative excitation of the panel's modes. This includes (but is not limited to) spectrally-rich features such as Mel and linear spectrograms and STFTs, MFCCs, and any filter bank in the bandwidth of the panel's isolated resonances.

Mel-frequency cepstral coefficients (MFCCs) were demonstrated to be an effective feature set for estimating DOA of recordings of phonemes in isolation made by sensors mounted on elastic plates. The speech signals used in this experiment contained full phonetic phrases. Therefore, in addition to the use of an MFCC feature set, Mel and magnitude spectrograms were also used as features to train the neural networks in an effort to accommodate the wider spectral and temporal variations associated with speech signals.

The models trained in this work employ two architectures that are compatible with TinyML, and are compact enough to be embedded on commercially available edge devices. The first of two architectures, is a two-dimensional convolution neural network (CNN) with a regression output layer. The second model, a recurrent neural network (RNN) was chosen because it is built into the hardware on the Syntiant NDP.

Distinct instances of both architectures were trained with each of the feature sets. Additionally, the RNN was trained with the proprietary feature set created for the Syntiant hardware accessible on Edge Impulse. Model training was performed using the wake words spoken by each participant individually, with 8880 wake word recordings split into training and validation sets with a ratio of 80:20. The remaining 2220 recordings were used to test each model. The models were trained to minimize the mean square error between the predicted angle and the ground truth. Note that because the models were each trained with only one voice, they serve as speaker-dependent proofs of concept. Generalization to a speaker-independent model is out of the scope of this work, although the results here suggest that these methods will generalize to a wide range of voices with different spectral content.

Each model was evaluated on its ability to correctly predict the true incident angle θi within a defined angular tolerance ±Δθi. Following, the reliability with which the model estimates the DOA of the speech source is expressed as the number of correct predictions within ±Δθi, divided by the total number of utterances tested. Experimental results are reported for angular tolerances of 5°, 10°, and 20°.

The reliability with which each model is able to estimate the DOA of the speech signal is shown in Table 10 above for various for angular tolerances. Reliability of the DOA estimates made by the trained CNNs and the RNNs with angular tolerances of 5°, 10°, and 20°. Distinct models were trained for each feature set and speaker.

The CNN was able to estimate the DOA of both participant's voices to within ±5° with up to 98.3% reliability using a single structural vibration sensor. The models trained with MFCC features under-performed the models trained with the more spectrally complete Mel and magnitude spectrogram feature sets. Additionally, the CNNs trained with magnitude spectrograms as features out-performed those using Mel spectrograms. This may be due to the linear spacing of the frequency bins in the magnitude spectrogram. At sufficiently high frequencies, a large number of the panel's bending modes are excited simultaneously. In this frequency region of high modal overlap, individual modes are no longer discernible, which mitigates the ability of the structural sensor to relate the modal excitations given to a specific angle of incidence. Therefore, the logarithmic nature of the Mel spectrogram may result in less efficient utilization of spectral information in the low-frequency region where low modal overlap occurs, and individual modes dominate the panel's spatial response. The use of panel-specific spectral features that optimize the bandwidths where individual modes are discernible is another embodiment.

The RNNs trained with non-proprietary feature sets were able to estimate the DOA of both participant's voices to within ±5° with up to 94.3% reliability. As was the case for the CNNs, the RNNs trained with MFCC features under-performed those trained with the other feature sets. However, the RNNs trained with Mel spectrograms generally outperformed the models trained with magnitude spectrograms. This may be related to the limitations imposed on training time by Edge Impulse, as the magnitude spectrograms were the largest features used in this experiment. Edge Impulse recently introduced the ability to deploy pre-trained models within their framework, so re-training the RNN architecture with these feature sets in an offline setting will be explored in future work.

The RNN trained with the proprietary feature set created for the Syntiant hardware performed very well when acting on the test set, as it estimated the DOA of both participant's voices to within ±5° with up to 99.9% reliability. The reported reliability of models trained with this hardware-informed feature set is an important result that can lead to the development of an optimized, full-stack system.

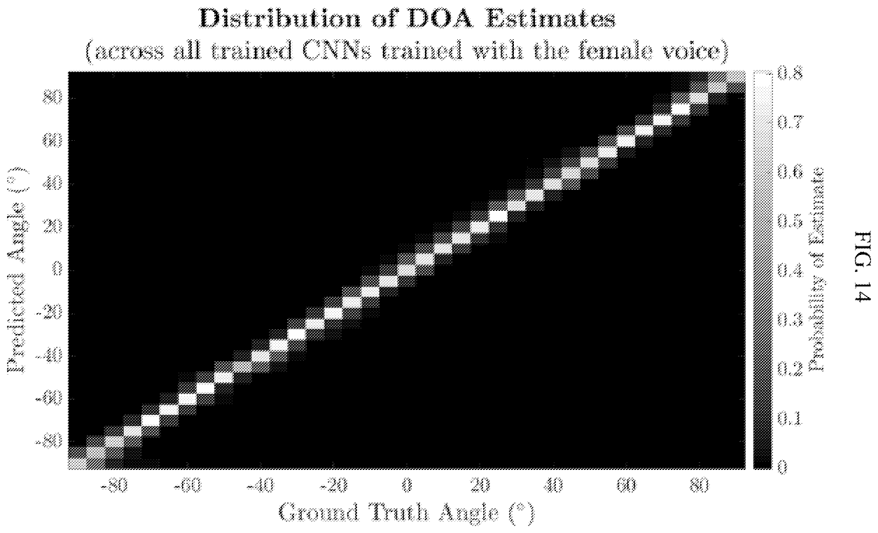

It is important to note that all of the trained models were able to estimate the DOA of both participant's voices to within ±10° with greater than 96% reliability. Comparing the results across the various angular tolerances indicates that the DOA estimates returned by the models are distributed around the true incident angles. This distribution is apparent in FIG. 14, which shows the aggregate confusion matrix for the CNNs trained with the female voice with an angular tolerance of ±5°.

The proposed single-sensor DOA method may be adaptable to various speech characteristics, as the voices used were inclusive of a wide range of vocal timbres.

The reported results provide experimental evidence that a single sensor affixed to an elastic panel can be utilized to perform reliable DOA estimation from recorded speech signals. In addition, the models and feature sets utilized in this work are all compact enough to be implemented within the constraints imposed by commercially available embedded/edge hardware. In particular, the performance of the RNN trained with the proprietary, hardware specific feature set indicates that designing a highly reliable, full-stack DOA estimation system utilizing the methods herein. The presented methods herein enable the DOA of a speech signal to be reliably estimated using a single sensor under these conditions.

This contrasts with the ubiquitous time-delay and phase-based approaches to DOA estimation require transducer arrays with multiple sensing elements. Reducing the number of sensors needed to perform the tasks required by modern smart devices may lower their power consumption, manufacturing cost, and computational requirements, while offering the ability to integrate the sensor into built environments without sacrificing form-factor.

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents. The contents of all references, including patent applications, such as U.S. application Ser. Nos. 15/255,366; 15/778,797; 15/753,679 and U.S. Prov. App. Nos. 62/745,307; 62/745,314, cited throughout this application, as well as the Figures and Tables, are incorporated herein by reference.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

1. A method for capturing directional sound using structural vibration sensing elements, the method comprising the steps of:
affixing one or more structural vibration sensing elements to an elastic base surface; detecting vibrations in the elastic base surface that are sensed by a structural vibration sensing element, wherein said vibrations are caused by acoustic pressure waves impacting upon said elastic base surface;
measuring a vibration signal from the vibrations in said base surface in response to the acoustic pressure waves that are impacting upon said elastic base surface;
inferring from the vibration signal in said elastic base surface the incident angle of the acoustic pressure waves at the point of impact on said elastic base surface, wherein inferences of the incident angle of the acoustic pressure waves are drawn based on vibration features extracted from the vibration signal that provide information on the relative modal excitations of the elastic base surface by the vibrations.

2. The method of claim 1, further comprising the step of networking said structural vibration sensing element to a computer processor.

3. The method of claim 1, wherein the base surface is a flat panel.

4. The method of claim 1, wherein the vibration features are derived using spectrally rich representations of the panel's vibrations, wherein said spectrally rich representations comprise one or more of mel and linear spectrograms and short time Fourier transforms (STFTs).

5. The method of claim 1, wherein the vibration features are cepstral coefficients derived using a filter bank whose frequencies are determined by the mel scale.

6. The method of claim 1, wherein the vibration features are frequency domain signal representations derived using a filter bank whose frequencies are determined by the resonant frequencies of the base surface.

7. The method of claim 1, wherein the vibration features are cepstral coefficients derived using a filter bank whose frequencies are determined by the resonant frequencies of the base surface.

8. A system for capturing directional sound using structural vibration sensing elements, the system comprising:
one or more structural vibration sensing elements, wherein a structural vibration sensing element is affixed to an elastic base surface;
a network connected to the structural vibration sensing element for capturing directional sound by:
detecting vibrations in the elastic base surface that are sensed by the structural vibration sensing element, wherein said vibrations are caused by acoustic pressure waves impacting upon said elastic base surface;
measuring a vibration signal from the vibrations in said base surface in response to the acoustic pressure waves that are impacting upon said elastic base surface;
inferring from the vibration signal in said elastic base surface the incident angle of the acoustic pressure waves at the point of impact on said elastic base surface, wherein inferences of the incident angle of the acoustic pressure waves are drawn based on vibration features extracted from the vibration signal that provide information on the relative modal excitations of the elastic base surface by the vibrations.

9. The system of claim 8, further comprising
a computer processor, wherein the computer processor is networked to the structural vibration sensing element;
a non-transitory computer-readable medium having computer-executable instructions stored thereon, said computer-readable instructions for capturing directional sound.

10. The system of claim 8, wherein the base surface is a flat panel.

11. The system of claim 8, wherein the vibration features are derived using spectrally rich representations of the panel's vibrations, wherein said spectrally rich representations comprise one or more of mel and linear spectrograms and short time Fourier transforms (STFTs).

12. The system of claim 8, wherein the vibration features are cepstral coefficients derived using a filter bank whose frequencies are determined by the mel scale.

13. The system of claim 8, wherein the vibration features are frequency domain signal representations derived using a filter bank whose frequencies are determined by the resonant frequencies of the base surface.

14. The system of claim 8, wherein the vibration features are cepstral coefficients derived using a filter bank whose frequencies are determined by the resonant frequencies of the base surface.

15. A method for capturing touch location on the surface of an elastic object using structural vibration sensing elements, the method comprising the steps of:
affixing one or more structural vibration sensing elements to an elastic base surface; detecting vibrations in the base surface that are sensed by the structural vibration sensing element, wherein said vibrations are caused by a touch impacting upon said base surface;
measuring a vibration signal caused by said touch impacting upon said base surface; inferring from the vibration signal the position of the touch at the point of impact on the base surface, wherein inferences of the position of the touch are drawn based on vibration measurements extracted from the vibration signal that provide information on the relative modal excitations of the base surface by the vibrations.

16. The method of claim 15, wherein networking said structural vibration sensing element to a computer processor.

17. The method of claim 15, wherein the vibrations induced by touch are recorded by the structural vibration sensing element directly.

18. The method of claim 15, wherein an external actuator induces vibrations in the base surface and the structural vibration sensing element records changes in the resulting driven vibrations of the elastic object when the touch force is applied to the surface of the elastic object when the base surface is touched.

19. The method of claim 15, wherein after the vibrations induced by touch are recorded by the structural vibration sensing element directly then an external actuator induces vibrations in the base surface and the structural vibration sensing element records changes in the resulting panel vibration when the base surface is touched.

20. The method of claim 15, wherein the base surface is a flat panel.

21-30. (canceled)
